(19) United States
(12) Patent Application Publication
(10) Pub. No.: US 2018/0313765 A1
(43) Pub. Date: Nov. 1, 2018

(54) SYSTEMS, DEVICES AND METHODS FOR ANALYZING AND IDENTIFYING SUBSTANCES

(71) Applicant: UNIVERSITY OF VIRGINIA PATENT FOUNDATION, Charlottesville, VA (US)

(72) Inventors: James P. Landers, Charlottesville, VA (US); Shannon Theresa Krauss, Palham, NH (US); Nishant Shukla, Hermosa Beach, CA (US)

(21) Appl. No.: 15/770,035

(22) PCT Filed: Oct. 21, 2016
(86) PCT No.: PCT/US2016/058304

§ 371 Date: Apr. 20, 2018

Related U.S. Application Data
(60) Provisional application No. 62/245,473, filed on Oct. 23, 2015.

(51) Int. Cl. G01N 21/78; G01N 21/07; B01L 3/00; G01N 31/22

(52) U.S. Cl. CPC G01N 21/78; G01N 21/07; G01N 2021/0325; G01N 31/22; B01L 3/5027

(57) ABSTRACT

A substance determination system comprises a chip comprising: a substrate; a microfluidic channel disposed on the substrate; a reagent enclosed in the microfluidic channel; and a substance inlet to the microfluidic channel; a centrifugal device configured to rotate the chip; and a micro-processor device configured to assess the reagent in the crofluidic channel. A method for identifying a substance comprises: inserting a substance into an inlet in a microfluid detection device having a reagent disposed in a microfluid circuit connected to a mixing domain; spinning the microfluid detection device to move the substance and the reagent to the mixing domain; capturing a digital image of a reaction between the substance and the reagent; analyzing the digital image of the reaction to determine a color parameter; comparing the color parameter to a reference parameter of a reference composition; and assessing the comparison to determine if the substance is the reference composition.

### CLAIM OF PRIORITY

This patent application claims the benefit of priority of U.S. Provisional Patent Application Ser. No. 62/245,473, entitled “Cost-Effective Polyester-Toner Microdevices with Cell Phone Detection for Field-Test Colorimetric Reactions, Such as Explosives and Narcotics,” filed on Oct. 23, 2015, which is hereby incorporated by reference herein in its entirety.

### BACKGROUND

The present disclosure relates generally to, but not by way of limitation, devices, systems and methods for identifying samples of unknown substances or threshold determination. In an exemplary application, the present disclosure relates to inexpensive and portable identification devices.

Rapid detection of various small molecules, narcotics and explosives presented here as examples, in the field is critical. Current colorimetric presumptive field tests require a number of different commercial, pre-packaged reagent ampule pouches to accommodate the large screening demand for identifying a specific substance. Other field techniques to screen for illicit drugs and explosives, for example, include portable Raman spectroscopy and Fourier transform infrared spectroscopy (FTIR). While both of these conventional laboratory techniques have been made more portable for field-testing, these techniques are cost-ineffective as initial screening methods for first responders and each contain additional disadvantages. Raman spectroscopy relies on a library of collected spectra from pure compounds, which are not representative spectra of samples collected in the field where interfering fluorescence from common drug cutting agents is observed [1]. Additionally, FTIR requires a time-consuming sample preparation step that is destructive to bulk sample and is sensitive to aqueous materials, allowing analysis of only tablets and powder samples [2]. An enhanced inexpensive handheld presumptive field test platform is needed to rapidly screen unknown compounds with a single sample input and yield an output that covers a wide range of possible compounds, such as narcotics and explosives.

While common colorimetric presumptive field tests are more portable than sophisticated conventional instrumentation, the reliance on subjective interpretation of color and operation is often problematic. Although seemingly simple directions for the operation of these kits, there is still a critical need for a trained user during operation and interpretation of results. Contaminants or additives in the sample are not accounted for, leaving only color changes that directly match the kit instructions can be considered as a positive result. Common complications that arise for these kits, using drugs and explosives kits as examples, include: 1) a closely related compound causing a seemingly identical color change, 2) poor training where the operator records any color change as positive, e.g. marquis reagent turns orange with methamphetamine and yellow with diphenhydramine (not a controlled substance), 3) poor training where the operator administers the test incorrectly, e.g. operator waits too long to read the marquis test which, given adequate time, will always result in a dark color, 4) improper documentation, e.g., the operator has the wrong test recorded for the narcotic or explosive documented, 5) poor quality/improper reagents used by the operator, 6) the use of expired kits and, finally, 7) storage of kits in the trunk of a car for extended periods of time.

### Overview

Whether individually, or in combination, the susceptibility of the test results is high, and this begs for a new approach: a technology that provides a rapid, fully automated chemical analysis system with an electronic detector removing the subjective human component from the analysis. This technology should have the capability to incorporate controls in the screening protocol to account for contaminants, and should not be needlessly complex. In fact, an approach that provides more efficient field identification with minimal training to operate enhances the probability that various communities, law enforcement and military for example, would adopt the platform into on-site analysis.

Microfluidic technologies in the form of micro-total analysis systems [3] (μTAS) or lab-on-a-chip [4] (LOC) devices, offer numerous advantages for field analysis including rapid analysis, cost-effective substrates and instrumentation, small reagent and sample volumes, and simple operating procedures. In fact, the fully-integrated microfluidic devices developed by Le Roux et al. for rapid human identification by short tandem repeat analysis [5] and Chin et al. for HIV detection [6] are examples where microfluidics has revolutionized testing. Over the last decade, exploitation of centrifugal force has resulted in Lab-on-a-CD systems that control fluid flow through rotation speed [7]. The centrifugal microfluidic or ‘rotation-driven microfluidic’ (RDM) device platform offers a unique advantage due to portability and potential ease of automation. Multiple fluidic processing steps can be automated by controlling a sequential increase in rotation speed, along with direction and duration. Successful adoption of a Lab-on-a-CD device would require cost-effective device fabrication with an inexpensive substrate, a fabrication process ideal for mass production, and capabilities for on-board reagent storage. Wet etching and photolithography fabrication methods require expensive cleanroom facilities to create glass and silicon devices [8]. A new generation of fabrication methods, e.g., soft lithography [9], hot embossing [10] and injection molding [11], provide a path to more cost-effective microdevices [12]. These ‘molding’ techniques require the tooling of a ‘master mold’ that is ideal for mass production, but not for the prototyping needed during design and development phases when new chemistries are implemented for new applications. We have devised what we believe is the most simplistic, functional and cost-effective prototyping method-laser Print, Cut and Laminate (PCL) fabrication. The laser PCL protocol offers a means to fabricate sophisticated microfluidic architecture using inexpensive, commercial-off-the-shelf materials (polyester overhead transparencies) and instrumentation (laser printer, plotter cutter, laminator). This process uses the printer toner as adhesive and the printer as a high precision tool for laying down this ‘adhesive’ to effectively bond multiple layers. In addition, toner localized in channels/chambers functions as a hydrophobic valves (not adhesive) [13]. The polyester transparencies have a silica surface coating that allows the polyester-toner (PeT) device surfaces to be hydrophilic, thus amenable to capillary action, a mechanism needed for easy filling of structures. Microfluidic structures are ‘cut’ into the middle device layers (plotter cutter or CO2 laser) and aligned with a custom-built alignment tool. The device is bonded by applying heat and pressure to the layers using an office laminator to produce the final device ready for use.

Developments indicate that, in addition to being a prototyping methodology, this process could easily be scale-up for manufacturing. The ‘printing’ that lies at the core of the fabrication process offers an additional unique opportunity—the printing of reagents for dry, on-board storage. With this scenario, printing is exploited to: 1) define the microfluidic architecture, 2) create a ‘valving’ layer and, now, 3) print the various reagents needed for narcotics and explosives detection on an additional layer that is laminated into the final device. Using a device design for 24 separate detection reactions, the cost per device (excluding capitalization) would be <$1 USD. This is more cost-effective by roughly an order of magnitude than current pouch-based tests that cost ˜$1.50-$2.50 per test [14]. Given the ability to print the reagents quantitatively with inkjet printed droplets (1.5 picoliter/drop) and the small volumes of the detection chambers (<5 μL), this cost could be very low (pennies per reaction). In addition to the elegance and low cost of printing the reagents, this inherently places reagents on-board and ready to react with added sample for effective field use. Printing leaves the reagent-dried state on the surface, i.e., in semi-lyophilized form, thus providing the potential for improved reagent stability. This circumvents the need for liquid reagent storage options using valves [15] and can potentially provide enhanced long-term reagent stability under different environmental conditions.

Simpler, alternative fabrication protocols have been defined for generating inexpensive LOC devices from paper and polyester-based microfluidic devices [12], with the paper-based analytical devices (μPADs) explored more extensively [16-18]. These μPADs exploit the inherent capillary action of paper to mobilize solution and reagents through channels defined by embedded wax to control the fluidic architecture. While elegant in fabrication simplicity, it is limited to relatively simple architectures and has poor bandwidth for volume metering, mixing, sequential reagent addition, and incorporating controls. However, the advantage of paper microfluidics that has not been exploited for other more complex techniques is the inherent reagent storage method used. During fabrication, paper-based devices spot and dry reagents onto the paper device before operation. We provide the first account of utilizing this paper reagent storage method to incorporate into a different platform to store reagents. When reagents could corrode or harm an inkjet printer, this is an alternative reagent storage method that could be used.

Finally, to develop an enhanced, less subjective field test method, a custom-written cell phone application is used to interpret color changes on the device. Images of the device are captured with the cell phone camera and the associated cell phone application utilizes thresholds to determine the presence or absence of a specific component. Thresholds are defined by various image analysis parameters from resulting colorimetric reactions, such as in the presence of specific drugs and explosives, to identify unknown field samples.

Stringent regulation of narcotics places the outcome of court cases, ultimately, on reliable identification of controlled substances. This pressure placed on laboratories to analyze field samples is not alleviated by current field identification methods for illicit drugs. Current presumptive test methods rely solely on subjective interpretation of color change using drug-specific colorimetric reactions. Common field testing complications arise from poor training, colorblindness, and varied chemical response due to improper storage and volume of sample input. Here, we describe a centrifugal microfluidic system for single-use, disposable microdevices that accepts embedded reagents using a complimentary reagent printing process. This system is designed for a modified CD player to drive fluid flow and an integrated Android cell phone as the colorimetric detector for field analysis. Methamphetamine and cocaine detection were achieved using these devices for an enhanced method for narcotics screening, thereby eliminating the subjective detection method of current techniques.

We report a centrifugal polyester-toner microdevice with reagent storage for colorimetric detection using a cell phone application. We demonstrate the utility of this method with narcotics and explosives detection, but this platform can extend to a large range of colorimetric reactions. Inexpensive device fabrication is expanded from the core laser Print, Cut and Laminate (PCL) protocol [13] to incorporate reagent storage through inkjet printing and reagent paper punches-both avenues that compliment the PCL technique by utilizing commercial materials. Color changes that occur on the developed devices can be detected by analyzing various image parameters with a cell phone application using photos taken with the same cell phone.

In an example, a substance determination system can comprise: a chip comprising: a substrate; a microfluidic channel disposed on the substrate; a reagent enclosed in a portion of the microfluidic channel; and a substance inlet to the microfluidic channel; a centrifugal device configured to rotate the chip; and a microprocessor device configured to assess the reagent in the microfluidic channel.

In an example, a method for identifying a substance can comprise: inserting a substance into an inlet in a microfluid detection device having a reagent disposed in a microfluid circuit connected to a mixing domain; spinning the microfluid detection device to move the substance and the reagent to the mixing domain; capturing a digital image of a reaction between the substance and the reagent; analyzing the digital image of the reaction to determine a color parameter; comparing the color parameter to a reference parameter of a reference composition; and assessing the comparison to determine if the substance is the reference composition.

In an example, a method of fabricating a microfluidic device for substance determination, the method comprising: forming a microfluidic channel architecture onto a substrate, the microfluidic channel architecture including an inlet, a passage, and a mixing domain; positioning a reagent adjacent the microfluidic channel architecture; and covering the substrate with a capping layer, the capping layer including an opening aligned with the inlet.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1A is a top view of an example of a microfluidic device for threshold determination and drug detection of the present application.

FIG. 1B is a bar chart showing hue and saturation of a reagent from colorimetric reactions with samples collected with the microfluidic device of FIG. 1A.

FIG. 1C is a close-up view of a microfluidic device channel architecture from the microfluidic device of FIG. 1A.

FIG. 1D is a top view of an example of a microfluidic device for threshold determination and drug detection of the present application

FIG. 1E is a bar chart showing saturation of a reagent from reactions with differing levels of cocaine concentration using the microfluidic device of FIG. 1D.

FIG. 1F is a bar chart showing unknown sample identification using the microfluidic device of FIG. 1D.

FIG. 1G is a close-up view of a microfluidic device channel architecture from the microfluidic device of FIG. 1D.

FIG. 2A is a top view of an example of a microfluidic device for threshold determination and drug detection of the present application.

FIG. 2B is a close-up view of a microfluidic device channel architecture from the microfluidic device of FIG. 2A.

FIG. 3A is an exploded view of a chip design for a reagent printed device that can include a microfluidic device of FIGS. 1A-2B.

FIG. 3B is a close-up view of a first example of printed reagent droplets on a bottom layer of the chip design of FIG. 3A.

FIG. 3C is a close-up view of a second example of printed reagent droplets on a bottom layer of the chip design of FIG. 3A.

FIG. 4A is a schematic diagram of a printed reagent on paper and polyester substrates.

FIG. 4B is a schematic diagram of a printed reagent on filter paper and polyester substrates.

FIG. 4C is a schematic diagram of a printing nozzle dispensing reagent droplets on a paper substrate.

FIG. 4D is a schematic diagram of a printing nozzle dispensing reagent droplets on a polyester film substrate.

FIG. 4E is a schematic diagram of a printing nozzle dispensing reagent droplets on a a rough polyester film substrate.

FIG. 5A is bar chart showing reagent stability over time.

FIG. 5B is a table summarizing the reagent stability over time of FIG. 5A.

FIG. 6 is a flow chart showing a process for incorporating reagent paper in a microfluidic device.

FIG. 7A is a perspective view of a smartphone mounted to a housing for taking a photograph of a microfluidic device within the housing.

FIG. 7B is a perspective view of a microfluidic device mounted to a system including a spin motor and an optical sensor.

FIG. 8A is a perspective view of a smartphone connected to a housing of a rotation-driven microdevice (RDM).

FIG. 8B is a screenshot of a smartphone showing an image of a detection area of a microfluidic device.

FIG. 8C is a screenshot of a smartphone showing a color change of a reagent in the detection area of FIG. 8B.

FIG. 8D is a screenshot of a smartphone identifying a substance associated with the color change of the reagent of FIG. 8C.

FIG. 8E is a bar chart showing hue of a reagent from reactions with samples having differing levels of cocaine concentration from analysis performed by the smartphone of FIGS. 8A-8D.

FIG. 9A is a perspective view of a substrate having a layer of toner coating that is laser-ablated to form a channel architecture for a microfluidic device.

FIG. 9B is a perspective view of a stack of layers for a microfluidic device showing multiple transparency layers and toner coating layers.

FIG. 9C is a perspective view of a laminating machine for laminating the layers of FIG. 9B.

FIG. 9D is a side view of a laminated microfluidic device of FIGS. 9A-9D.

FIG. 9E is a top view of a laminated microfluidic device of FIGS. 9A-9D.

FIG. 10A is a schematic illustration showing a change in color of octahedral cobalt with the addition of cocaine.

FIG. 10B is a schematic illustration showing a change in color of sodium nitroprusside acetone (Simon's reagent) with the addition of methamphetamine or amphetamine and sodium carbonate.

FIG. 11A is a bar chart showing hue of a reagent for differing values of cocaine concentration.

FIG. 11B is a bar chart showing saturation of a reagent for differing values of cocaine concentration.

FIG. 12 is a bar chart hue of a reagent for differing values of methamphetamine and amphetamine concentrations.

FIG. 13A is a bar chart showing hue of a reagent for differing values of methamphetamine concentration over time.

FIG. 13B is a bar chart showing hue of a reagent for differing values of cocaine concentration over time.

FIG. 14A is a chart showing hue of a reagent for different substances in a drug mixture.

FIG. 14B is a chart showing saturation for different substances in a drug mixture.

FIG. 15A is a chart showing hue for differing values of methamphetamine concentration mixed with different additives.

FIG. 15B is a chart showing hue for differing values of cocaine concentration mixed with different additives.

FIG. 16A is a chart showing hue for different samples of unidentified drugs.

FIG. 16B is a chart showing saturation for different samples of unidentified drugs.

FIG. 17 is a chart showing hue for differing values of cocaine concentration for different colors.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

This invention incorporates the polyester-toner device architecture, reagent storage on the device, and detection method for drugs and explosives. The laser print, cut and laminate (PCL) protocol that we have previously described [13]. This method offers a means to fabricate sophisticated microfluidic architectures using inexpensive, commercial off-the-shelf materials and instrumentation to ultimately combine multiple colorimetric tests into a single device for a cost-effective and rapid on-site screening technique. The devices are fabricated from polyester overhead transparencies using a laser printer, laser cutter, and office laminator.

### Device Architecture

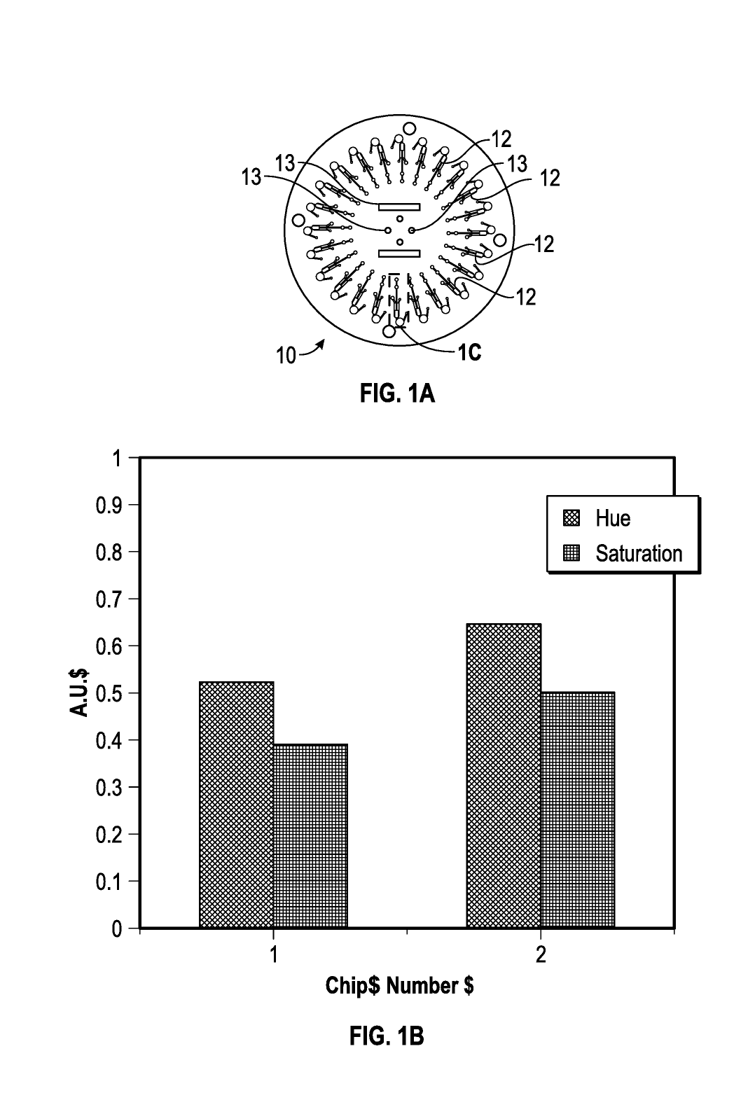

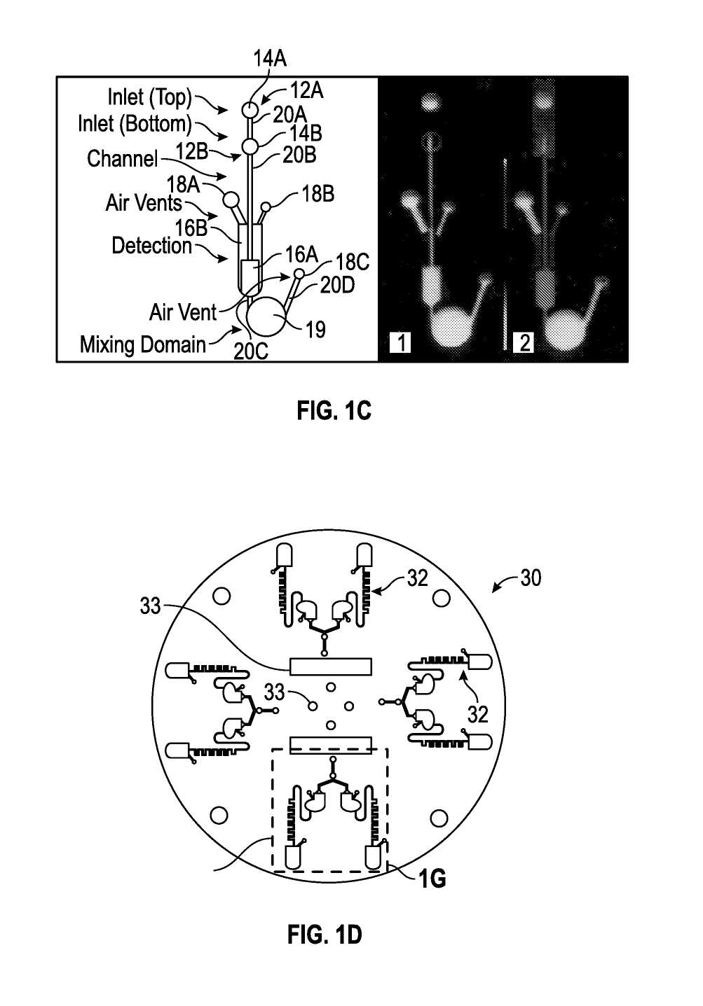

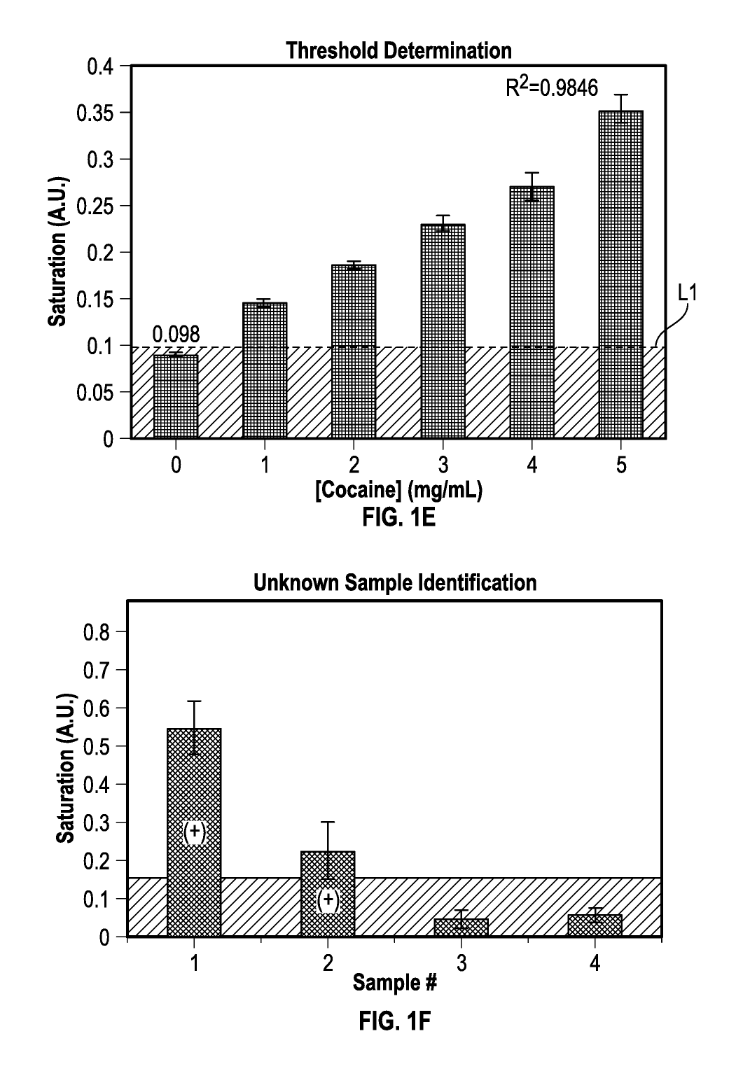

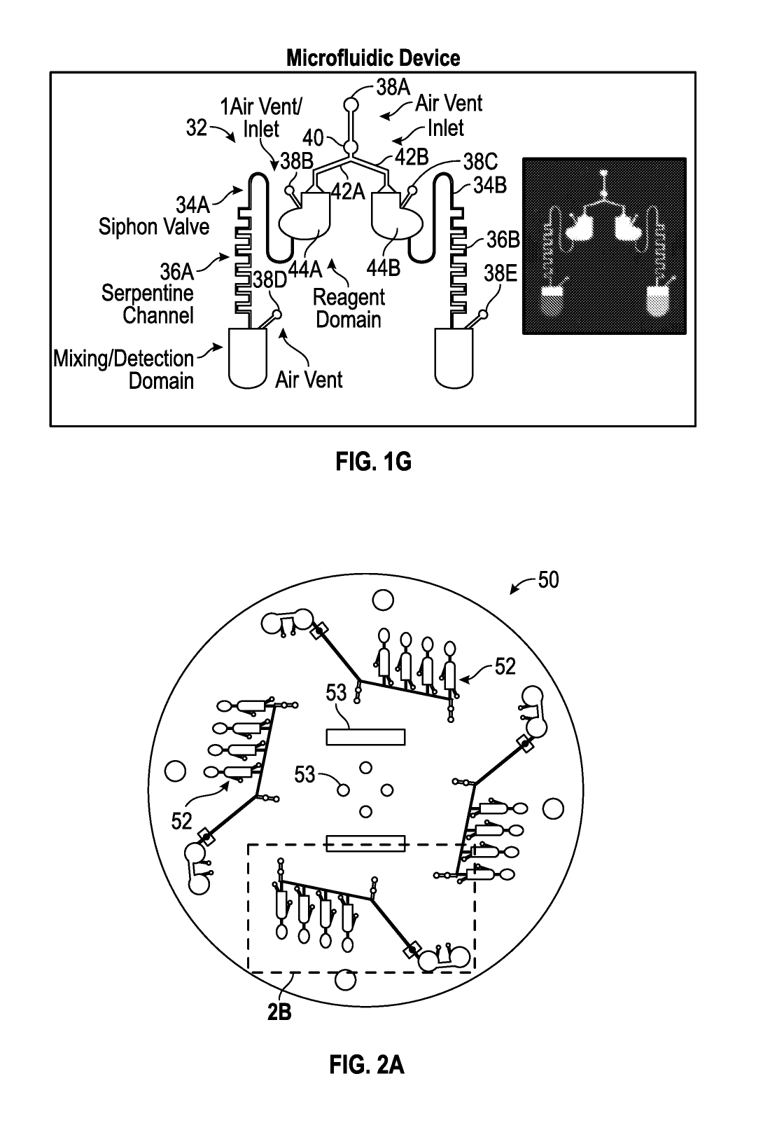

FIGS. 1A-1F show microfluidic devices for threshold determination and drug detection. FIG. 1A shows microfluidic device design for threshold determination with FIG. 1C describing each feature of the design. Cocaine (1) and methamphetamine (2) colorimetric reactions performed using the described design. FIG. 1B shows hue and saturation values from the colorimetric reactions are shown. FIG. 1D shows microfluidic device design for drug detection from a single sample input with inset describing each feature of the design. Methamphetamine and cocaine colorimetric detection locations using the described design are shown. The threshold determination and drug or substance detection devices described herein can be used to determine a color parameter of a mixture of one or more reagents with a test substance or a solution including the test substance. The color parameter, such as hue or saturation, can be used to identify the test substance. For example, the hue or saturation can be compared to a reference parameter of a reference substance. The reference parameter can include various thresholds or ranges of hue and saturation. For example, a threshold value of saturation can be determined from a reference substance, such as cocaine, in order to compare the saturation of an unidentified test substance. In other examples, a range of hue values can be determined from a reference substance, such as methamphetamine, in order to compare the hue values of an unidentified test substance.

FIG. 1A is a top view of an example of threshold determination device 10 having a plurality of microfluidic channels 12 for threshold determination and drug detection. FIG. 1C is a close-up view of one microfluidic channel 12 of threshold determination device 10 of FIG. 1A. Device 10 can also include openings 13 for connecting to a centrifugal machine, such as a spin motor or a DC drive.

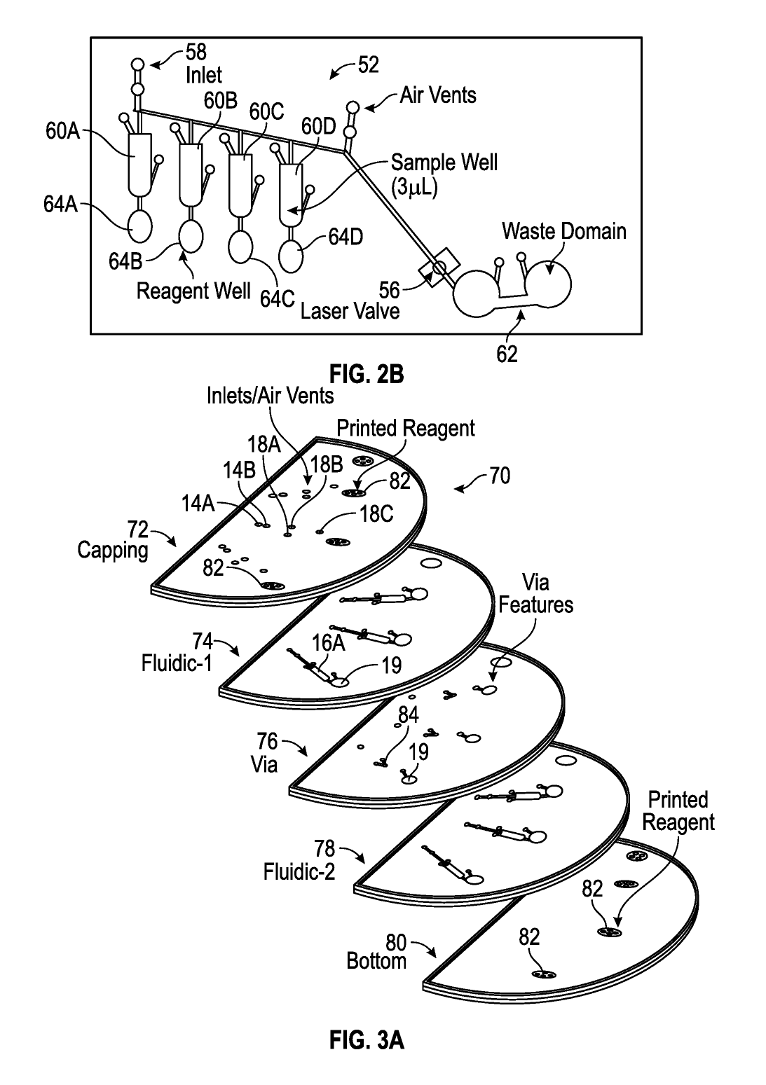

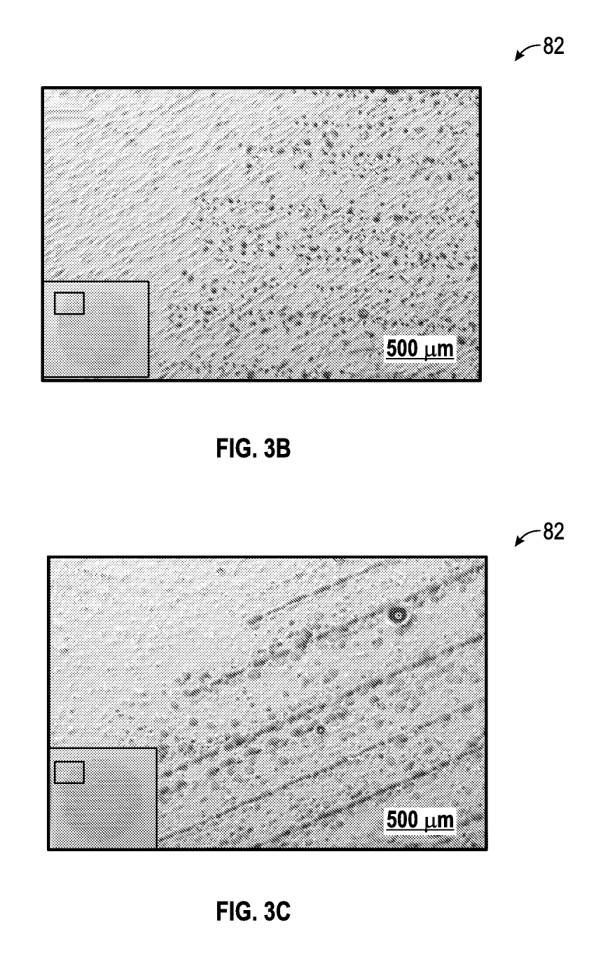

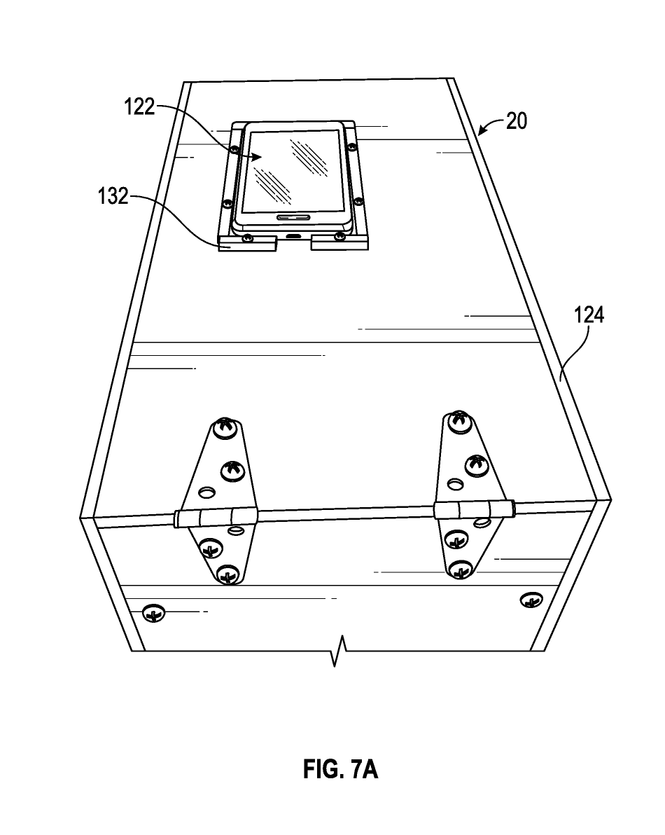

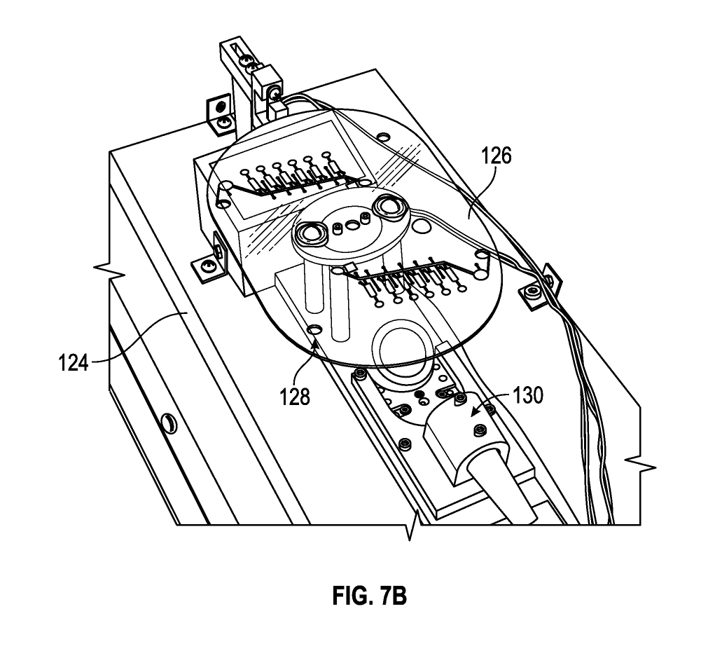

Threshold determination device 10 comprises two nearly identical channel architectures 12A and 12B overlaid and exploited for mixing. See, for example, the two-layer chip design of FIG. 3A. As can be seen in FIG. 1C, microfluidic channel 12 includes two separate inlets 14A and 14B provide access to two separate detection chambers 16A and 16B for holding 1 μL and 3 μL volumes, respectively, and each detection chamber 16A and 16B was roughly 124 μm in thickness, the size of one laser-ablated toner sheet. Both detection chambers 16A and 16B had entrances to a larger mixing well 19, with approximately 348 μm thickness from three laser-ablated layers. Capillary action held each solution in the detection chambers 16A and 16B until the solutions were centrifugally forced to the peripheral mixing well at 1,000 RPM, such as by using the machine of FIG. 7B. Microfluidic channel 12 also includes air vents 18A, 18B and 18C, and passages 20A, 20B, 20C and 20D.

FIG. 1B is a bar chart showing hue and saturation of a reagent from colorimetric reactions with samples collected with the microfluidic device of FIG. 1A. Samples collected with threshold determination device 10 can be mixed with reagents stored in detection chambers 16A and 16B within mixing well 19. The mixture changes color, the hue and concentration of which can be analyzed to determine the identity of the samples, such as by using the device of FIG. 7A.

FIG. 1D is a top view of an example threshold determination device 30 having a plurality of microfluidic channels 32 for threshold determination and drug detection. FIG. 1G is a close-up view of one microfluidic channel 32 of threshold determination device 30 of FIG. 1D. Device 30 can also include openings 33 for connecting to a centrifugal machine, such as a spin motor or a DC drive.

Threshold determination device 30 comprises a number of features for fluidic control including device symmetry, capillary valves, siphon valves 34A and 34B, serpentine channels, 36A and 36B, strategically placed air vents 38A, 38B, 38C, 38D and 38E, and inlet 40.

The sample solution enters through inlet 40 and flows into both sides of the device 30 via passages 42A and 42B. The solution remains in the top square section of the reagent domains 44A and 44B and is held there by utilizing geometry through severe chamber widening and air vent placement, which effectively creates an air pocket around the vents 38A and 38B. The siphon valves 34A and 34B can then prime while the sample interacts with the reagents before completely filling the serpentine channels 36A and 36B. Once primed, the solution is spun into the serpentine channels 36A and 36B to assure appropriate mixing of sample and reagent. The solution is then kept in the serpentine channels 36A and 36B until the spin speed overcomes the capillary valve due to an extreme increase in well size compared to the serpentine channels 36A and 36B. The channel is one laser-ablated layer and the final mixing well is three laser-ablated layers.

FIG. 1E is a bar chart showing saturation of a reagent from reactions with differing levels of cocaine concentration using the microfluidic device of FIG. 1D. Increasing concentration levels of cocaine move from left to right. Correspondingly, increasing levels of saturation are achieved as the concentration level increases. For zero cocaine concentration, as shown by the leftmost bar in FIG. 1E, the saturation remained below a threshold level L1.

FIG. 1F is a bar chart showing unknown sample identification using the microfluidic device of FIG. 1D. A positive correlation with cocaine was determined with the two leftmost bars that were above the saturation threshold level L1. A negative correlation with cocaine was determined with the two rightmost bars that were below the saturation threshold level L1.

FIG. 2A shows a microfluidic device design for explosives detection with FIG. 2B describing each feature of the design. FIG. 2A is a top view of an example threshold determination device 50 having a plurality of microfluidic channels 52 for threshold determination and drug detection. FIG. 2B is a close-up view of one microfluidic channel 52 of threshold determination device 50 of FIG. 2A. Device 50 can also include openings 53 for connecting to a centrifugal machine, such as a spin motor or a DC drive.

Threshold determination device 50, or drug detection device, incorporates a ‘centrifugo-pneumatic valve’ 54 [19] and laser valve 56 [20] to control fluidic movement. These valves were implemented because some samples are dissolved in organic solvents, which are unaffected by hydrophobic toner valves. The sample solution enters the inlet 58 and fills all of the metering chambers 60A, 60B, 60C and 60D. The device is spun to ensure the chambers 60A-60D are completely filled. Then, the waste laser valve 56 is opened to allow and excess solution to move into the waste chamber 62. Then the device 50 is spun at a high speed compatible with the centrifuge-pneumatic valve 54 to force the sample into the reagent domains 64A, 64B, 64C and 64D. Current experiments use laser and siphon valves in multi-step reactions.

Embodiments of the devices described herein, e.g., devices 10, 30 and 50, currently utilizes polyester. Other potential materials might include: heat sensitive adhesive, pressure sensitive adhesive, or hydrophobic membranes. Polyester-toner refers to toner-coated polyester that serves as an adherent material, or area-specific toner printed for alignment, or for valving, as a hydrophobic valve or for a laser valve. Toner can be replaced by black polyester or using other substrates mentioned above.

### Reagent Storage by Printing Reagents

FIGS. 3A-3B show a chip design for Reagent Printed Devices (RPD). FIG. 3A shows a schematic of a 5-layer mixing chip describing each polyester and toner-coated polyester layer. The role of each layer is described, with the top and bottom layer for the printed reagents. FIG. 3B shows a bright field microscopy image (4× magnification) of the edge of a reagent spot printed ten times on TRANSNS smooth film. FIG. 3C shows a bright field microscopy image (4× magnification) of the edge of a reagent spot printed ten times on Universal Apollo Inkjet film.

FIG. 3A is an exploded view of a chip design for reagent printed device 70 that can include a microfluidic device of FIGS. 1A-2B. Reagent printed device 70 can include capping layer 72, fluidic-1 layer 74, VIA layer 76, fluidic-2 layer 78 and bottom layer 80. Capping layer 72 can include inlets and vents for the various microfluidic channels described herein, such as microfluidic channels 12. Thus, for example, capping layer 72 can include openings for inlets 14A and 14B and air vents 18A, 18B and 18C. Capping layer 72 can also include printed reagent 82 at the locations of mixing well 19. Fluidic-1 layer 74 can include various feature of the various microfluidic channels described herein. For example, Fluidic-1 layer 74 can include inlets 14A and 14B, detection chambers 16A and 16B, air vents 18A, 18B and 18C, mixing well 19, and passages 20A, 20B, 20C and 20D. Fluidic-2 layer 78 can include various feature of the various microfluidic channels described herein. For example, Fluidic-1 layer 74 can include inlets 14A and 14B, detection chambers 16A and 16B, air vents 18A, 18B and 18C, mixing well 19, and passages 20A, 20B, 20C and 20D. VIA layer 76 can include various features for connecting the various microfluidic channels of Fluidic-1 layer 74 and Fluidic-2 layer 78. For example, VIA layer 76 can include mixing well 19 and vias 84. Bottom layer 80 can include various features of the various microfluidic channels described herein. For example, bottom layer 80 can include printed reagent 82 at the locations of mixing wells 19. Vias 84 of VIA layer 76 can connect the various portions of microfluidic channels 12 to promote mixing as threshold determination device 10 is spun or rotated about a center point of threshold determination device 10, as described in greater detail below.

FIG. 3B is a close-up view of a first example of droplets of printed reagent 82 on bottom layer 80 of the chip design of FIG. 3A. FIG. 3C is a close-up view of a second example of droplets of printed reagent 82 on bottom layer 80 of the chip design of FIG. 3A. Printed reagent 82 is printed onto capping layer 72 and bottom layer 80 to align with features in fluidic-2 layer 78, such as mixing well 19.

Inkjet printer modifications. Printing was performed using an EPSON R280 printer with modifications described previously [21, 22]. Refillable ink cartridges were purchased through a third-party vendor for modifications in place of the stock EPSON ink cartridges. The refillable ink cartridges were modified using a Dremel® drill to fit a P200 pipette tip. The ink cartridge connector that extends from the bottom of the cartridge to the print nozzle was removed. A hole was then drilled into the front of the ink cartridge above the connector hole approximately 25 mm tall and 12 mm wide. The ink cartridge embedded chip and plastic support to hold the cartridge together were kept intact to guarantee that the cartridge fits normally into the printer. The end of a P200 pipette tip was cut until the tip fit tightly over the print nozzle to become the new reservoir to hold printing solutions.

Printer preparation for printing reagents. The printer was cleaned and conditioned between each device printing session. To clean the printer, a 12 mL plastic syringe (inkproducts.com) and silicon tubing (5 mm o.d.) was used to push cleaning solutions through the print head nozzle onto a paper towel placed below the print head. Ethanol, isopropyl alcohol, ethanol, water, and air were sequentially used to flush the print head. Once cleaned, a new P200 pipette tip was cut to fit tightly around the nozzle over the print head, acting as a reservoir to hold the reagent solution. Reagent was added to the reservoir and a P200 pipette was placed on the pipette tip reservoir to push reagent through the print head nozzle onto a paper towel for conditioning. The printing reservoir was filled again with 150 μL of reagent for printing. Ink cartridges were returned to the appropriate printer compartment and situated into the ‘home position’ to lock in place. No error messages were confirmed when the printer was turned on before printing reagents.

Polyester layer preparation for printing. A compact disc (CD) was placed in the printing tray designated for CD labels. P5 filter paper (11 cm diameter) purchased from Fisher Scientific (Pittsburg, Pa.) was taped on top of the CD in the tray. Dye solution was printed onto the filter paper using the EPSON Print CD software. The printed dye regions were used to align the pre-cut capping and bottom reagent layers for printing. Different ink cartridges were chosen (e.g. blank and cyan) to print two different reagents simultaneously. The designed printing regions in the EPSON Print CD Software were coordinated with each ink cartridge for cyan (0 red, 0 green, and 255 blue) and black (0 red, 0 green, and 0 blue).

To overcome the need for incorporating additives, inkjet transparencies with a rough surface were employed, as shown in FIGS. 3A, 3B and 3C. For example, capping layer 72 and bottom layer 80 can be made of transparent plastic that can be roughened at the location of mixing well 19 and other locations. The enhanced surface area provided by the rough surface was considerably more effective at trapping the individual droplets.

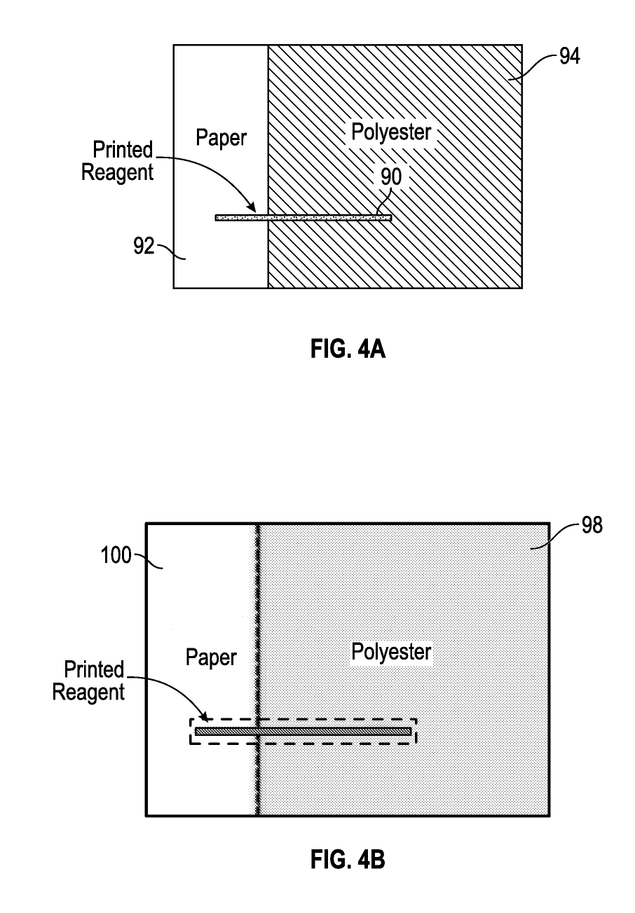

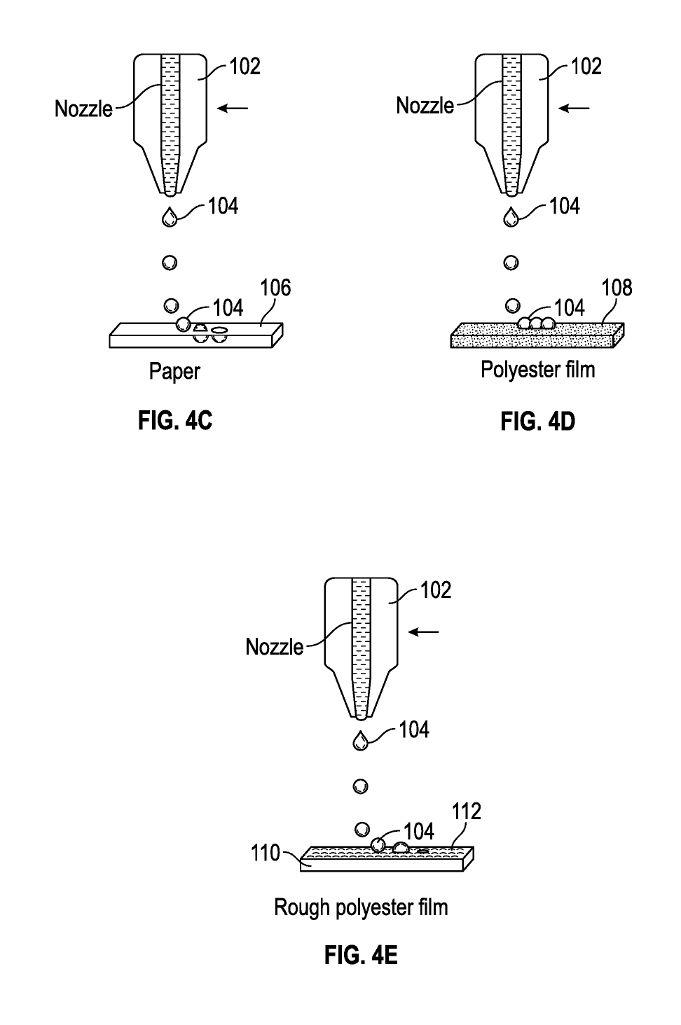

FIGS. 4A-4E show inkjet printing droplets onto various substrate material. FIG. 4A is a schematic diagram of a printed reagent 90 on paper substrate 92 and polyester substrate 94. FIG. 4A shows a diagram of initial attempts of printing reagent 90 onto polyester substrate 94 comprising polyester film by overlapping paper with transparency to start the print stream on paper to maintain printing onto the polyester film. FIG. 4B is an image of a printed reagent 96 on filter paper and polyester substrates. FIG. 4B shows an actual image of printed tetrabromophenol blue (TBPB) reagent (96) onto polyester film 98 using filter paper 100 to initiate printing.

FIGS. 4C-4D are schematic illustrations showing inkjet printing droplets demonstrating droplet interactions with different microdevice material. FIG. 4C is a schematic diagram of printing nozzle 102 dispensing reagent droplets 104 on paper substrate 106. Droplets 104 absorb down into paper substrate 106. FIG. 4D is a schematic diagram of printing nozzle 102 dispensing reagent droplets 104 on polyester film substrate 108. Droplets 104 partially absorb down into polyester film substrate 108. FIG. 4E is a schematic diagram of printing nozzle 102 dispensing reagent droplets 104 on polyester film substrate 110 at rough area 112. When droplets are printed onto paper, the droplets get absorbed into the porous cellulose-based substrate and dry. Non-porous polyester film does not absorb the printed droplets causing multiple droplets to combine on the surface and no drying occurs. Inkjet polyester film with a rough surface allows more surface area for the printed droplet to interact with and dry onto the surface.

The trapped droplets dry more rapidly in comparison to the larger droplets, formed by adjoining individual droplets, onto the non-absorbent film, as shown in FIGS. 4A-4E. Moving from smooth surface transparencies, that we traditionally use with PCL fabrication, to a rough inkjet-specific transparency immediately improved the printability of the reagents. However, introducing rough surfaces for the top and bottom microdevice layers affected the fluidic movement for the spin-stop mixing protocol, which relies on capillary action to back-fill the solution. Parameters such as channel length, channel diameter, and fluid viscosity effect how long it will take a solution to fill a channel by capillary action. The greater surface area introduced by the rough channel walls increased the channel length and slightly decreased the channel diameter, hindering efficient back-filling of more viscous samples via capillary action. To overcome this, a five-layer device design was used that incorporated a smooth transparency film as the middle layer to promote back-filling for the spin-stop mixing protocol. The smooth transparency film permitted only one of the channel walls to be comprised of rough transparency film.

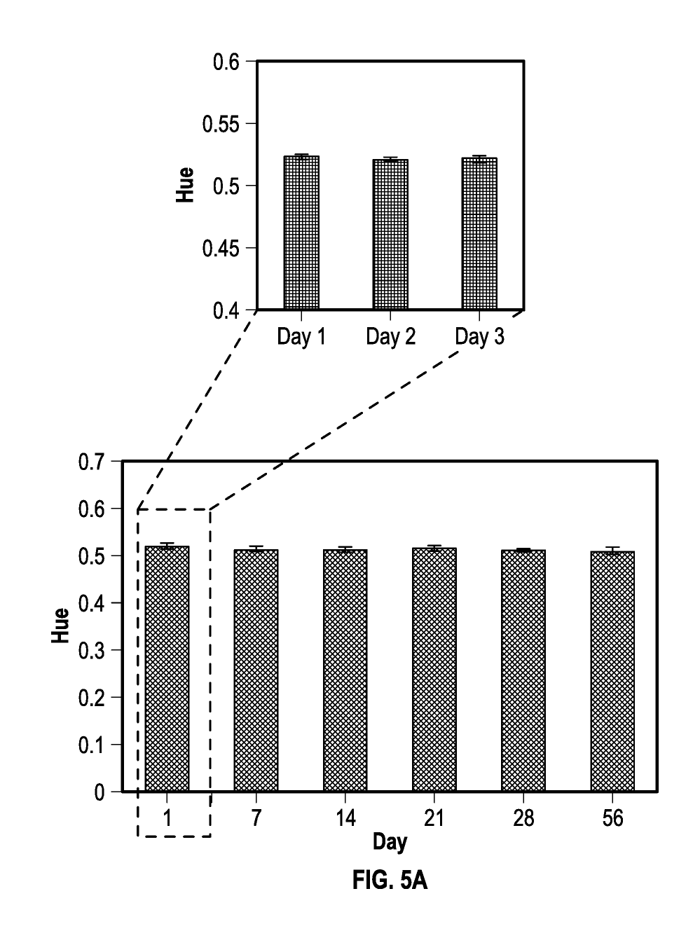

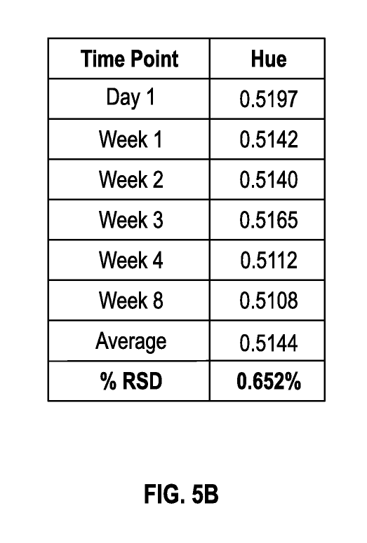

Printed reagent stability test using total protein-sensitive reagent. Device stability was initially measured over three days and then expanded into a long-term shelf life analysis, as shown in FIGS. 5A and 5B. It is critical for microfluidic devices aiming to be used as an alternative to conventional analytical techniques to have stability over time for storage and transportation. Our devices had minimal storage requirements allowing printed tetrabromophenol blue (TBPB) devices to be stored at room temperature and kept in a drawer, as indicated in the reagent MSDS. Reagent exposure to lamination during fabrication and the microdevice material during storage seemed to have no effect on stability. At each time point, the addition of HSA to the devices resulted in a blue color change and quantitatively, minimal detection changes occurred. FIGS. 5A and 5B show the low percent relative standard deviation (%RSD) over 8 weeks, 0.652%, indicates no loss in activity of the printed reagent.

FIGS. 5A and 5B show printed TBPB Device Stability. FIG. 5A is bar chart showing reagent stability over time. FIG. 5B is a table summarizing the reagent stability over time of FIG. 5A. As shown in FIG. 5A, the hue was consistently maintained over time out to at least fifty-six days. As shown in FIG. 5A, tetrabromophenol blue printed devices were stored at room temperature and analyzed over eight weeks, with an inset showing the initial three day stability. As shown in FIG. 5B, hue values are displayed in the table demonstrating no loss of activity over four weeks.

### Reagent Paper Storage

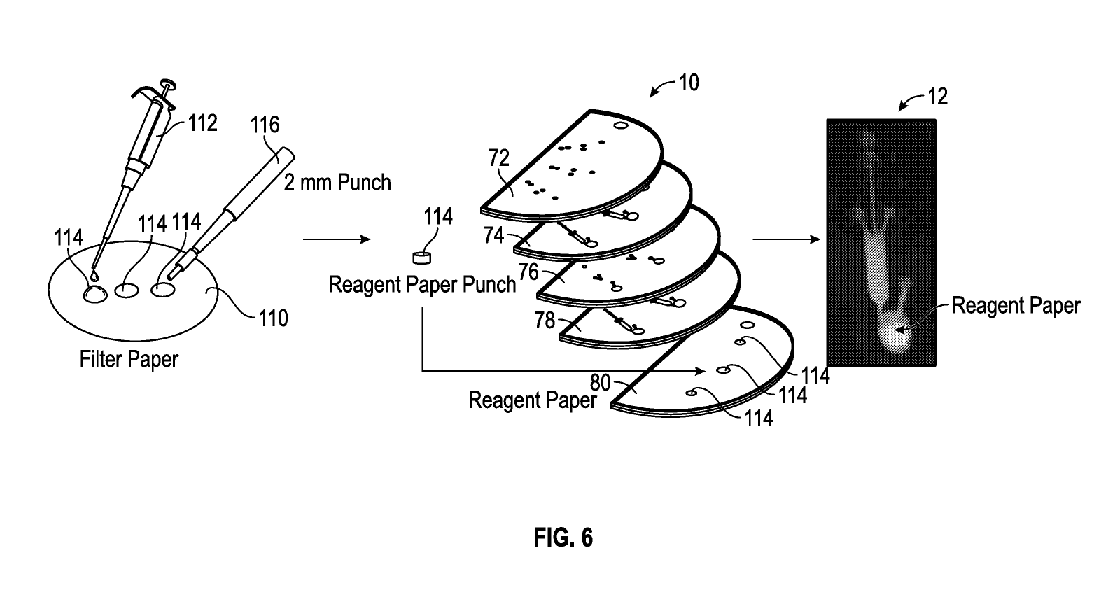

FIG. 6 is a flow chart showing a process for incorporating reagent paper in a microfluidic device. FIG. 6 shows also shows a developed fabrication process for incorporating reagent paper punches. At step A, a specific colorimetric reagent is spotted onto Whatman 1 grade filter paper 110 (experimentally determined) using dripper 112 and allowed to dry to form reagent paper spots 114. At step B, 2 mm Acu-Punch® disposable biopsy punches 116 are used to cut out the reagent paper spots 114. Once the spots 114 are placed into a reagent domain of the polyester-toner device, as shown at step C (similar to FIG. 3A), the top polyester layer of the device is added to enclose the reagent paper in the well to bond device 10. The device is then laminated with the reagent punches enclosed to form the various microfluidic channels 12, as shown in step D.

### Detection

FIG. 7A is a perspective view of analysis system 120 smartphone 122 mounted to housing 124 for taking a photograph of microfluidic device 126 (FIG. 7B) within housing 124. FIG. 7B is a perspective view of microfluidic device 126 mounted to spin motor 128 and optical sensor 130 within housing 124. Smartphone 122, housing 124, microfluidic device 126, spin motor 128 and optical sensor 130 comprise components of analysis system 120.

Images of the resulting color changes from drug-specific and explosive-specific colorimetric reagents are taken using a camera, in this case one from smartphone 122. However, housing 124 can be used in conjunction with a camera from another system. The camera of smartphone 122 is positioned above microfluidic device 126 using a custom-built PMMA holder 132. Holder 132 is 10 cm in height. The images are manually cropped in a custom-written application, here deployed in a smart cell phone operating system for smartphone 122. Image analysis optimization and validation can be performed by scanning the devices using an EPSON V100 Perfection Photo scanner at 1200 dpi resolution. Scanned images can be cropped and analyzed using ImageJ and Mathematica programs.

### Detection Analysis

Under conditions where the observed color change is either not intense or in the part of the color spectrum where a positive result is not obvious, the system can be augmented using a ‘tinting’, or color manipulation, approach. The detectable color change can be improved for smartphone or other camera-based image detection in several ways: 1) a physical filter with the desired spectral characteristics can be inserted between the light source and detection chamber, 2) since microdevice fabrication involves printing, toner can be printed above or below (or both) detection chamber to tint the color of the light detected by the camera, or 3) for reactions using reagent-embedded filter paper punches, the paper can be ‘pretreated’ as a means of tinting the subsequent. All of these approaches can allow for a shifting of the post-reaction ‘resultant color’ in a way that improve the sensitivity or lower the detection limit. An example of this is when a yellow to red color change could be changed to a green to purple color change when the punch is tinted blue, to provide greater discrimination between the original results.

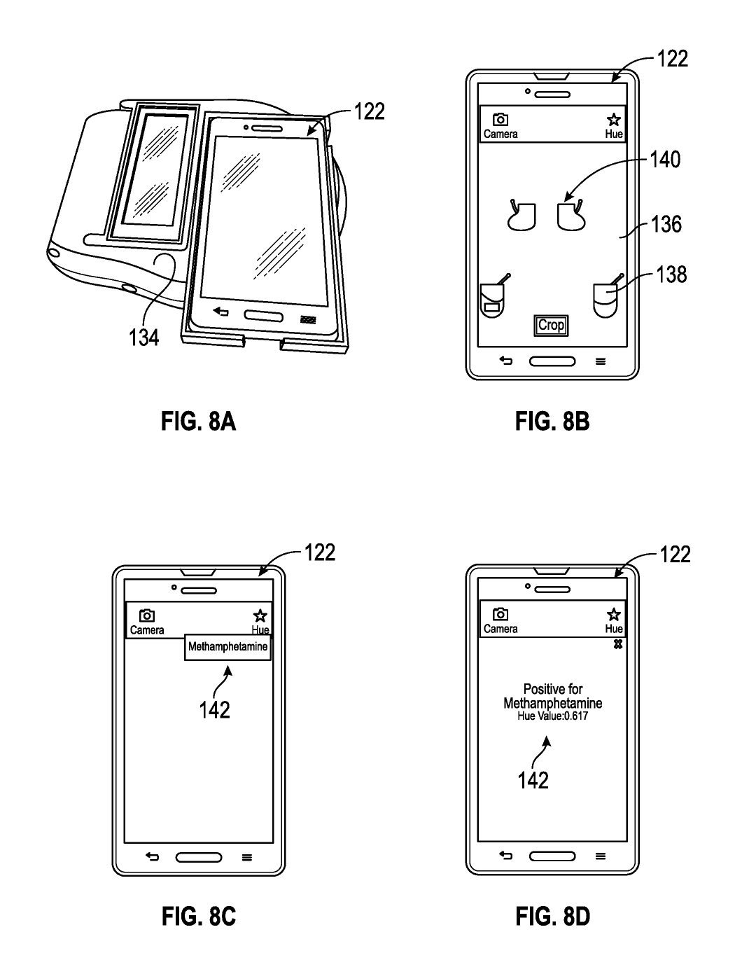

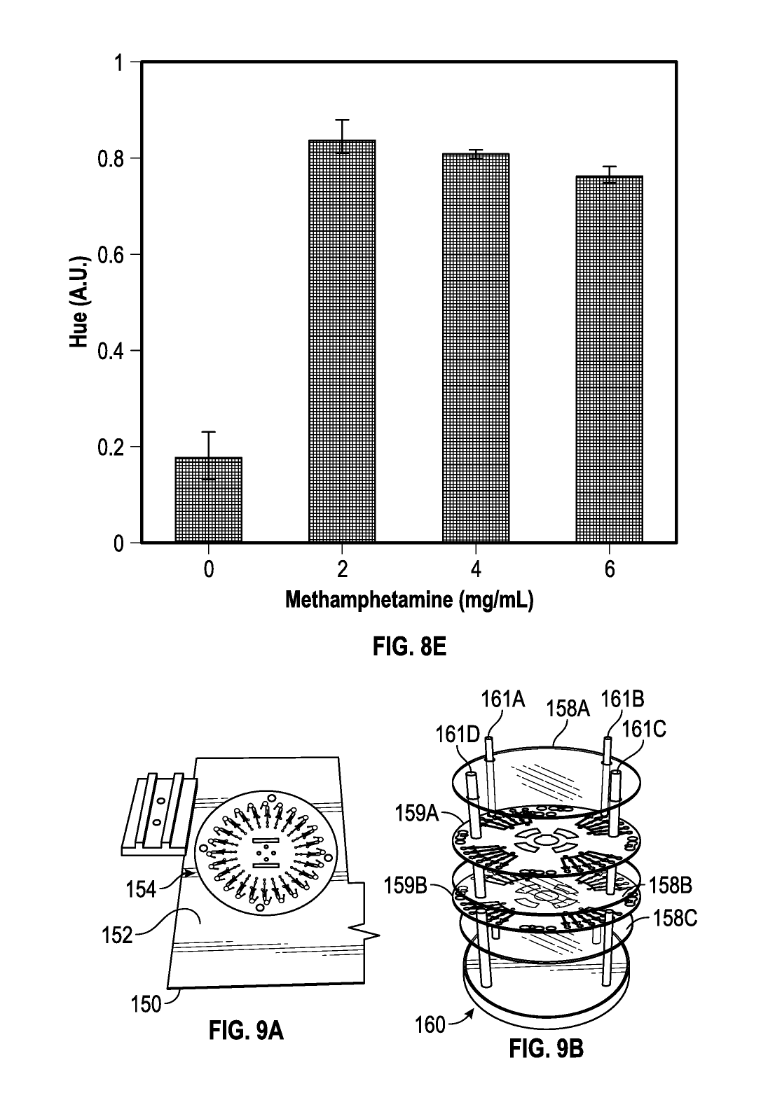

FIG. 8A is a perspective view of smartphone 122 connected to a housing of compact rotation-driven microdevice (RDM) 134. RDM 134 can apply a spinning force to one of devices 10 to mix a loaded sample with a reagent. RDM 134 can align the camera of smartphone 122 with one or both of the mixing well and detection area in order to take a photograph of the reaction that occurs between the reagent and sample. The photograph image taken by smartphone 122 can subsequently be analyzed via software present in smartphone 122 to analyze, among other things, the hue and saturation of the reaction for comparison to previously determined threshold levels of various substances to determine the identity of the sample. FIG. 8B is a screenshot of smartphone 122 showing image 136 of a detection area 138 of microfluidic device 140. FIG. 8C is a screenshot of smartphone 122 showing a color change of a reagent in detection area 138 of FIG. 8B. FIG. 8D is a screenshot of smartphone 122 identifying a substance associated with the color change of the reagent of FIG. 8C via indicia 142. Indicia 142 can comprise a digital graphical indication provided on smartphone 122, such as a spelling of the identified substance, or suggests as to possible identities of the substance, or indications that the substance does not match any reference information stored in smartphone 122, or other similar information. FIG. 8E is a bar chart showing hue of a reagent from reactions with samples having differing levels of cocaine concentration from analysis performed by the smartphone of FIGS. 8A-8D.

### System

In one embodiment, the components incorporated into a system would accommodate a microfluidic device where sample, in liquid or solid form, was loaded into the microdevice that when exposed to some form of force (mechanical, gravitational, heat energy, gas expansion, etc) and/or solvent delivery, via blister packs for example, facilitates sample movement from a load site to the location of the embedded reagents; subsequent interaction of sample components with the reagent(s) allows for a color-based detection end-result for explosives and narcotics detection. This system could incorporate a spin motor, cameras, software, laser actuators, optical sensors, cell phone, etc. to achieve these results. This (approach, system, detection, reagent storage, etc) can be extended to any sample/reagent combination where a color change results.

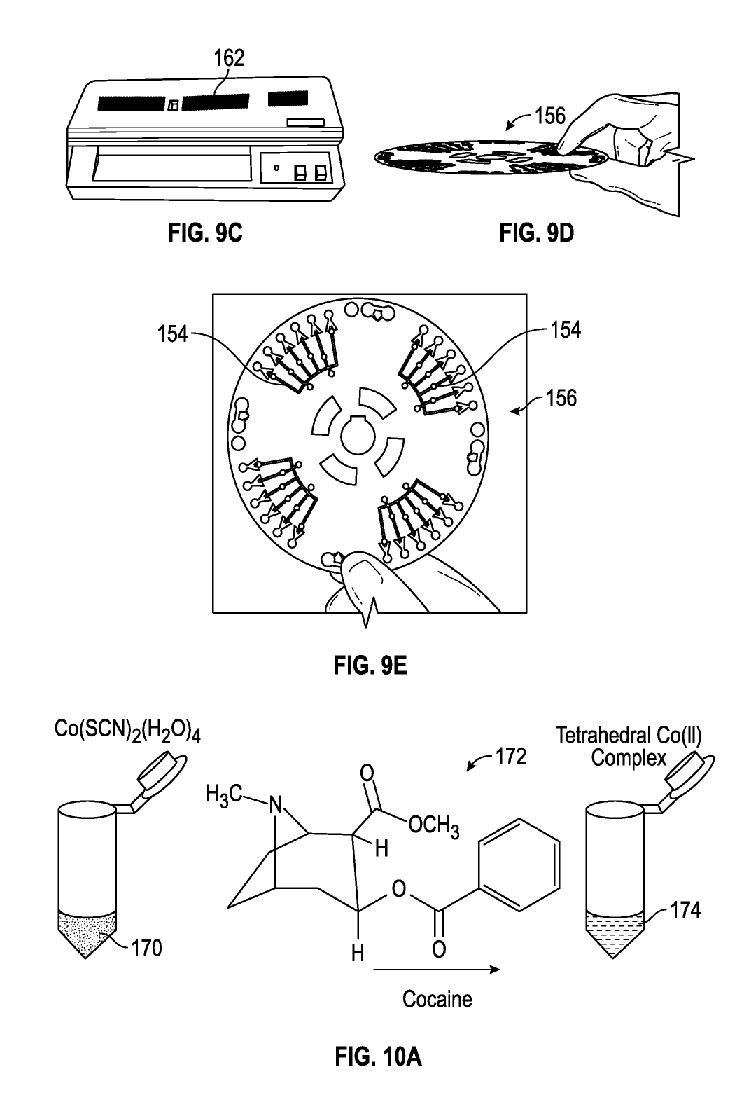

FIG. 9A is a perspective view of a substrate 150 having a layer of toner coating 152 that is laser-ablated to form channel architecture 154 for microfluidic device 156. FIG. 9A shows a portion of a PCL fabrication process. FIG. 9B is a perspective view of stack of layers for microfluidic device 156 showing multiple transparency layers 158A, 158B and 158C and toner coating layers 159A and 159B. Layers 158A-158C and layers 159A and 159B can be aligned with a custom alignment tool 160 having posts 161A-161D that pass through holes in the layers to align features of each layer properly to form microfluidic device 156. FIG. 9C is a perspective view of laminating machine 162 for laminating the layers of FIG. 9B. FIG. 9D is a side view of laminated microfluidic device 156 of FIGS. 9A-9D. FIG. 9E is a top view of laminated microfluidic device 156 of FIGS. 9A-9D.

The laser Print, Cut, and Laminate (PCL) fabrication method was used to develop various devices described herein. This method can utilize inexpensive, commercial, off-the-shelf materials (polyester overhead transparencies) and instrumentation (laser printer, laser cutter, laminator). Microfluidic structures 154 are cut into the middle device layers 159A, 159B and aligned with an alignment tool 160 for bonding. Device 156 is bonded by applying heat and pressure to the layers using office laminator 162.

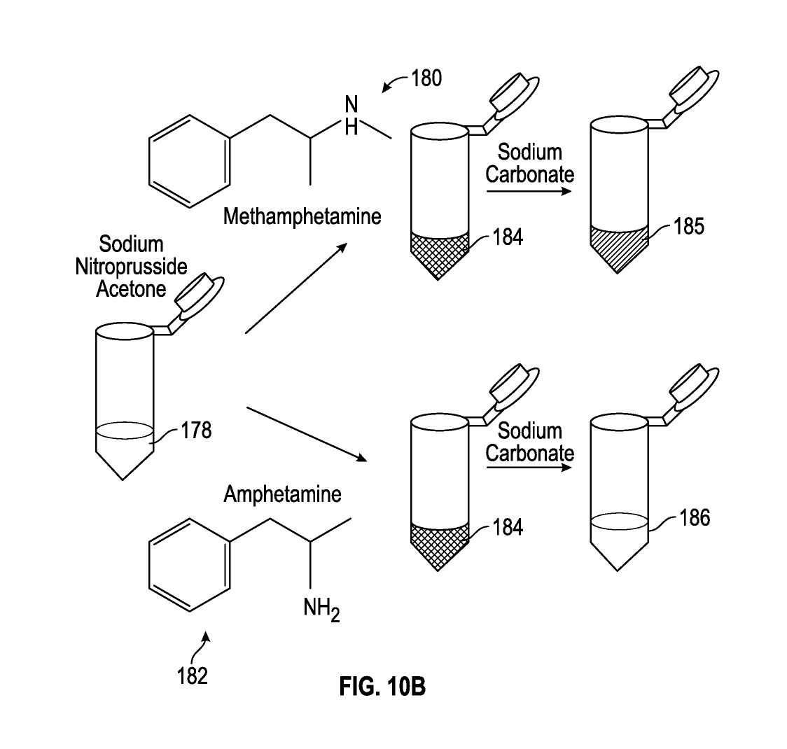

FIGS. 10A and 10B show colorimetric detection of drug samples. Simon's reagent is used for a two-step process of identifying methamphetamine, resulting in a purple color change. Simon's reagent in the presence of amphetamine resulted in no color change, equivalent to a negative sample.

FIG. 10A is a schematic illustration showing a change in color of octahedral cobalt 170 with the addition of cocaine 172. The mixture of octahedral cobalt 170 with cocaine 172 forms Tetrahedral Co(II) Complex 174. Tetrahedral Co(II) Complex 174 is darker in color than octahedral cobalt 170 without cocaine 172. In particular, octahedral cobalt 170 can be pink in the absence of cocaine, while Tetrahedral Co(II) Complex 174 can be blue.

FIG. 10B is a schematic illustration showing a change in color of sodium nitroprusside acetone (Simon's reagent) 178 with the addition of methamphetamine 180 or amphetamine 182 and sodium carbonate 184. The mixture of Simon's reagent 178 and sodium carbonate 184 with methamphetamine 180 and with amphetamine 182 produces different results. Simon's reagent 178 is very light in color. The mixture of Simon's reagent 178 and sodium carbonate 184 with methamphetamine 180 resulted in a purple color change at 185. The mixture of Simon's reagent 178 and sodium carbonate 184 with amphetamine 182 resulted in no color change at 186.

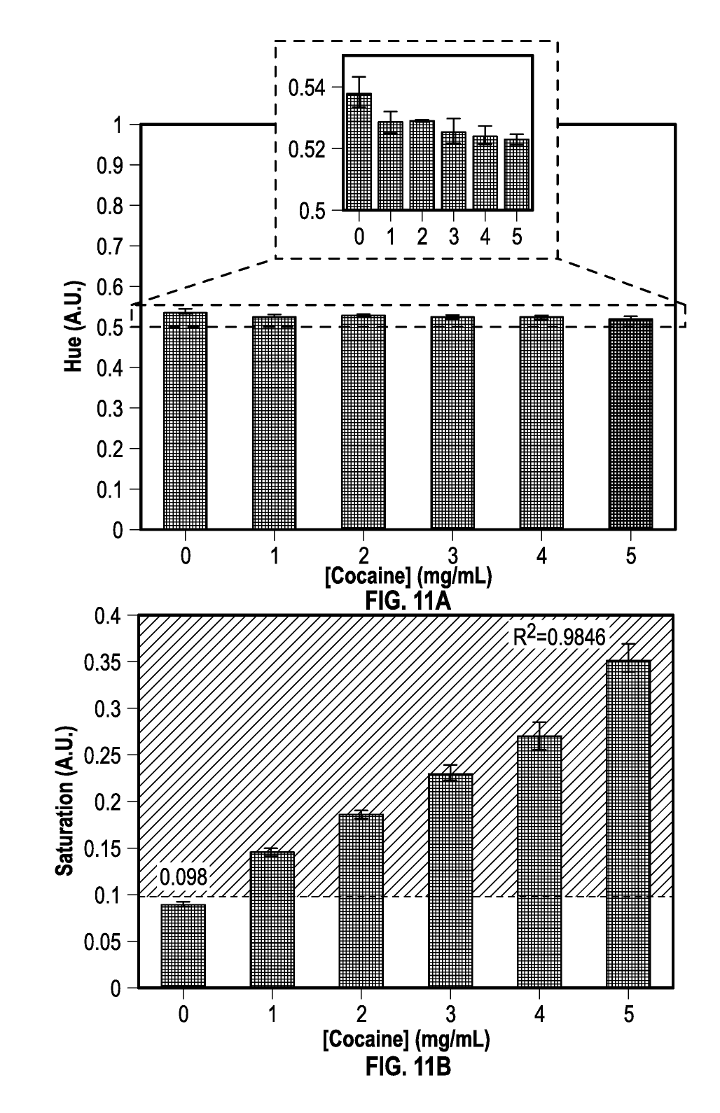

FIG. 11A is a bar chart showing hue of a reagent for differing values of cocaine concentration. FIG. 11B is a bar chart showing saturation of a reagent for differing values of cocaine concentration. FIGS. 11A and 11B show Defining Threshold Values for Cocaine using Saturation. As shown in FIG. 11A, hue was not adequate to define a threshold value for the presence of cocaine due to the small dynamic range over negative and positive standards. As shown in FIG. 11B, saturation was the better parameter for determining the presence of cocaine. FIG. 11B shows increasing saturation for samples having increasing cocaine concentration. A threshold value was determined at 0.098 A.U. by three-times the standard deviation of a negative standard using cobalt thiocyanate.

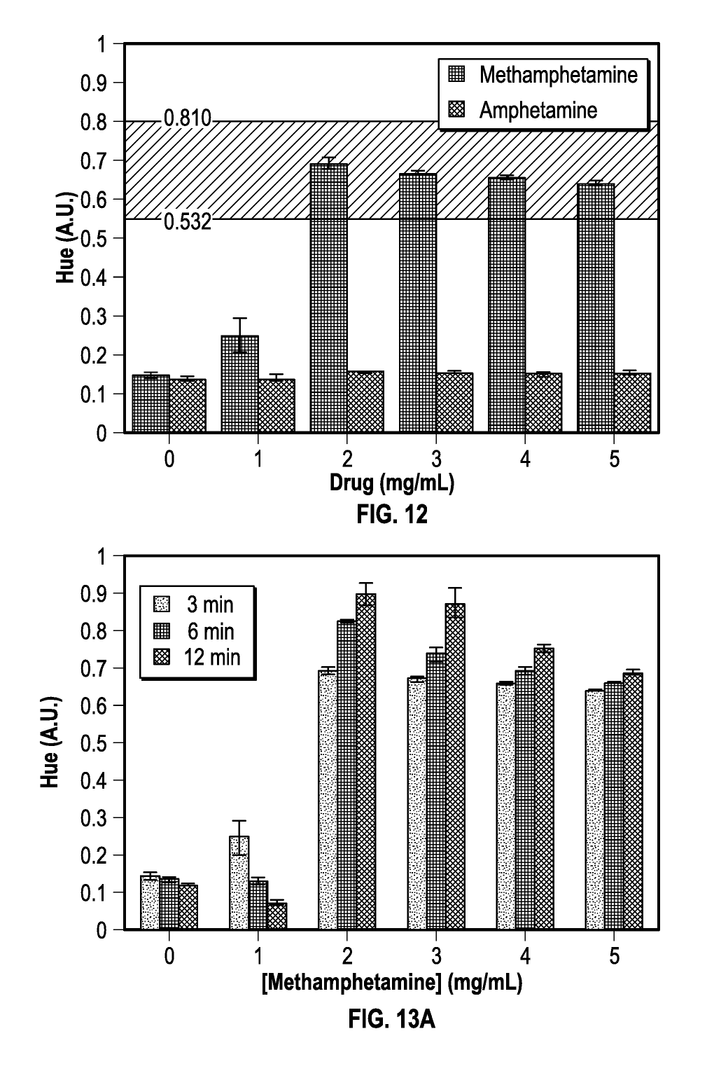

FIG. 12 is a bar chart hue of a reagent for differing values of methamphetamine and amphetamine concentrations. In FIG. 12, amphetamine was shown to form a baseline hue for different concentrations of amphetamine, as shown by the right-hand bars, while methamphetamine was shown to have increasing hue for increasing concentrations of methamphetamine. FIG. 12 shows Defining Threshold Values for Methamphetamine using Hue. Hue was adequate to define a threshold range for the presence of methamphetamine due to the increase in hue for positive standards. A range with the upper limit of 0.810 A.U. and lower limit of 0.532 A.U. was defined by three times the standard deviation of the average hue for concentrations 2-5 mg/ml. Any hue value outside of this range can be considered for a negative sample or the presence of amphetamine using Simon's reagent.

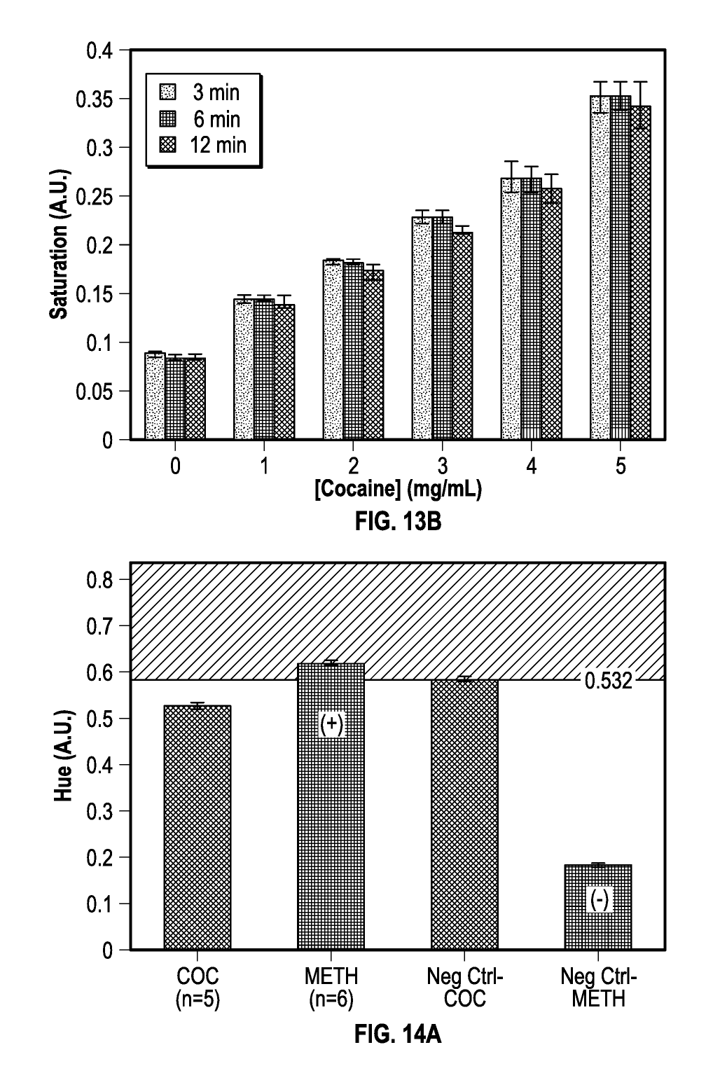

FIG. 13A is a bar chart showing hue of a reagent for differing values of methamphetamine concentration over time. FIG. 13B is a bar chart showing hue of a reagent for differing values of cocaine concentration over time. FIGS. 13A and 13B show Optimizing Detection Time for Colorimetric Reactions. As shown in FIG. 13A, image capture at 3 min can be used to identify positive methamphetamine samples. For higher concentrations of methamphetamine (2, 3, 4 and 5 mg/mL), the hue values tended to rise over time. However, over time, the hue values for lower concentrations of methamphetamine (0, 1 mg/mL) fell below the threshold line and are read as false negatives. In FIG. 13B, image capture at 3, 6, or 12 min can be used to identify positive cocaine samples for each concentration level.

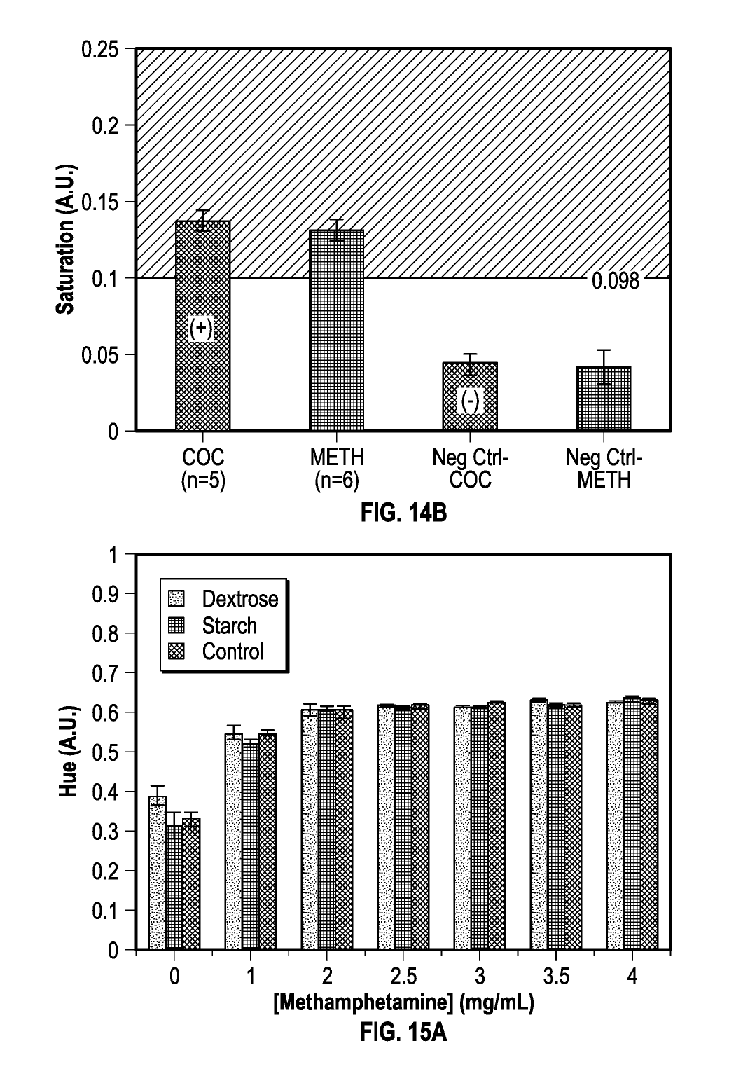

FIG. 14A is a chart showing hue of a reagent for different substances in a drug mixture. FIG. 14B is a chart showing saturation for different substances in a drug mixture. FIGS. 14A and 14B show Substance Identification in a Drug Mixture. Image analysis of a sample containing both methamphetamine (METH) and cocaine (COC) is shown in FIGS. 14A and 14B, respectively. As shown in FIG. 14A, hue values were used to detect methamphetamine in a mixture with cocaine using Simon's reagent. As shown in FIG. 14B, saturation values were used to detect cocaine in a mixture with methamphetamine using the cobalt thiocyanate reagent.

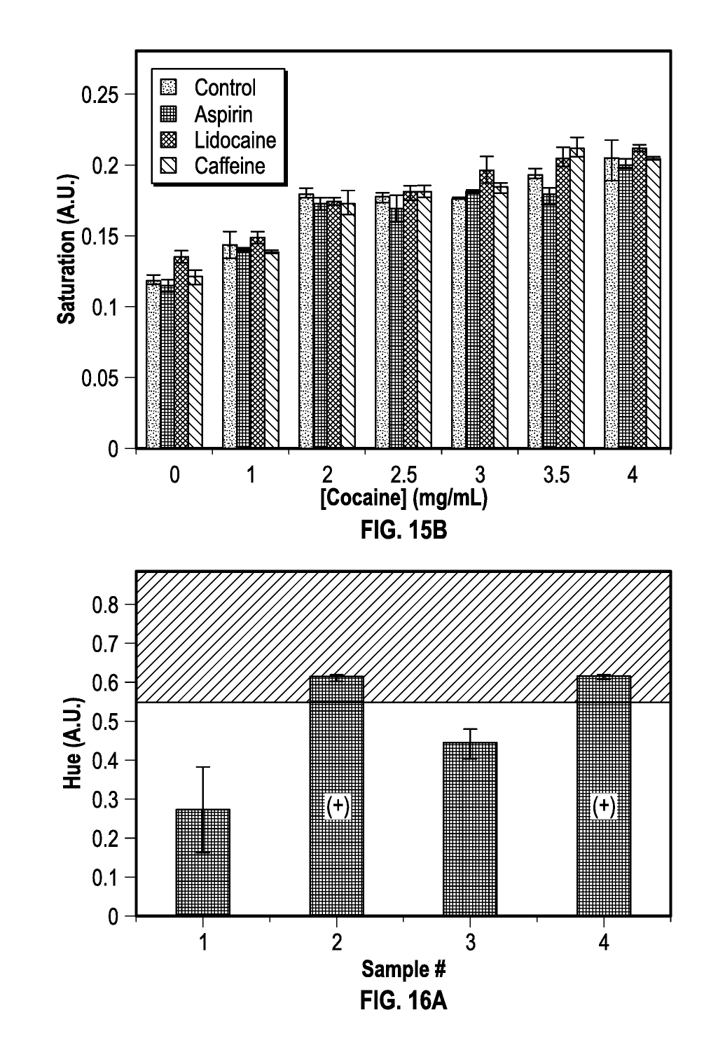

FIG. 15A is a chart showing hue for differing values of methamphetamine concentration mixed with different additives. FIG. 15B is a chart showing hue for differing values of cocaine concentration mixed with different additives. FIGS. 15A and 15B show Detecting Cocaine and Methamphetamine with Additives. As shown in FIG. 15A, hue values for methamphetamine at various concentrations with additive (equal w/w). All negative samples fell below the threshold range, resulting in no false positives. As shown in FIG. 14B, saturation values for cocaine concentrations with additive (equal w/w). Some negative samples with additive resulted in higher saturation values than the control negative, leading to false positive results in the presence of lidocaine requiring a new threshold for analysis.

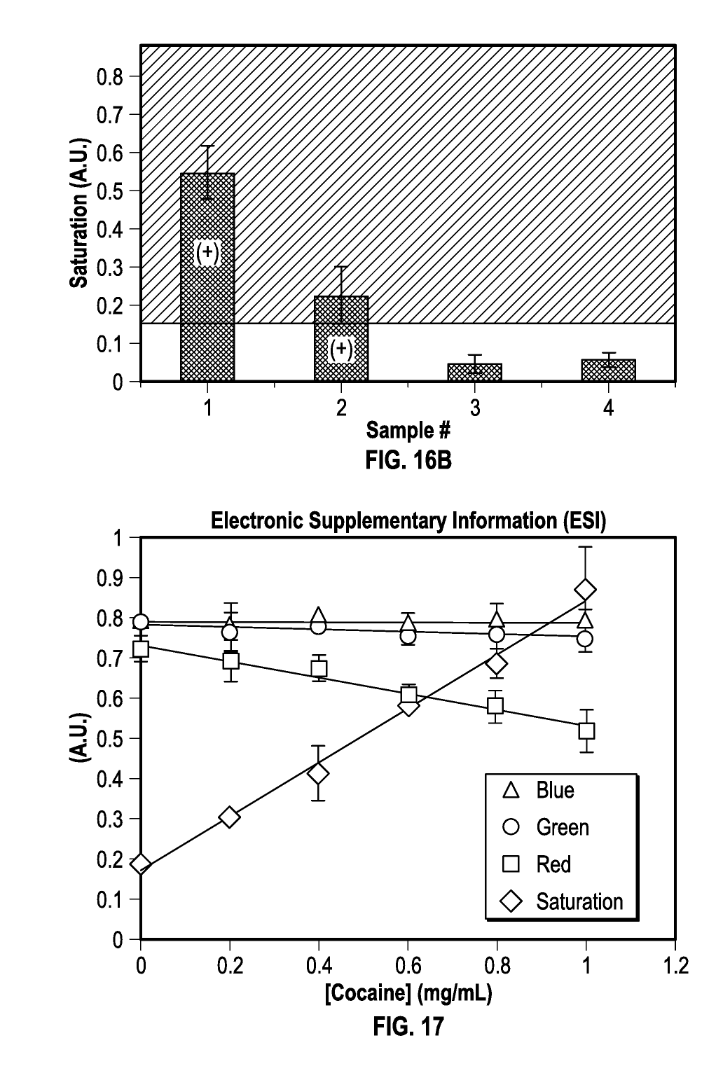

FIG. 16A is a chart showing hue for different samples of unidentified drugs. FIG. 16B is a chart showing saturation for different samples of unidentified drugs. FIGS. 16A and 16B show Drug Identification in Unknown Samples. Four samples were prepared with unknown amounts of methamphetamine and cocaine. Sample 1 was cocaine, sample 2 was methamphetamine, sampel 3 was cocaine and methamphetamine, and sample 4 was blank. Using the microfluidic device and threshold values defined for image analysis as described herein, the identity of each sample was determined. Hue was assessed for methamphetamine determination, as shown in FIG. 16A, and saturation was assessed for cocaine determination, as shown in FIG. 16B.

FIG. 17 is a chart showing hue for differing values of cocaine concentration for different colors. FIG. 17 show Cocaine Image Analysis with RGB Color Model. Comparing the chosen image analysis parameter for cocaine, saturation, with RGB color analysis. The color change for cocaine is blue-green which is mostly comprised of blue and green color at each concentration, resulting in small dynamic ranges. There is more variability in the amount of red color, but the dynamic range is substantially smaller than the saturation analysis parameter.

### Towards a Cost-Effective Rotation-Driven Microdevice for Rapid Detection of Illicit Drugs

Current colorimetric detection and identification of illicit drugs rely solely on a subjective interpretation of color change using drug- or class-specific reactions. Here, we describe the use of polyester-toner centrifugal microfluidic devices as an alternative for current presumptive colorimetric testing of illicit drugs, allowing for decreased reagent consumption, inexpensive device fabrication, and an objective image analysis technique for detection. The centrifugal microfluidic platform further accommodates the simultaneous presumptive drug testing from a single sample input to multiple reaction chambers, enabling rapid screening. Hue and saturation image analysis parameters were used to define thresholds for the detection of cocaine, methamphetamine, and amphetamine. Thresholds were also addressed with various drug additives to assure minimal cross reactivity. We demonstrate the effectiveness of the method by successfully identifying the composition of unknown samples at varying concentrations.

### EXAMPLES

### Introduction

Current colorimetric presumptive field tests for illicit drugs require a number of different commercial, pre-packaged reagent ampule pouches to accommodate the large screening demand for identifying a specific substance. Other field techniques to screen for illicit drugs include portable Raman spectroscopy and Fourier transform infrared spectroscopy (FTIR). While both of these conventional laboratory techniques have been made more portable for field-testing, these techniques are cost-ineffective as initial screening methods for first responders and each contain additional disadvantages. Raman spectroscopy relies on a library of collected spectra from pure drug compounds, which are not representative spectra of drug samples collected in the field where interfering fluorescence from common drug cutting agents is observed. Additionally, FTIR requires a time consuming sample preparation step that is destructive to bulk sample and is sensitive to aqueous materials, allowing analysis of only tablets and powder samples.

Microfluidic technologies have seen an increased interest for applications in forensic analyses due to the advantage of low reagent use and sample consumption, fast analysis times, inexpensive materials, and increased portability for on-site analyses. Over the last decade, exploitation of centrifugal force for fluid flow control in microfluidic devices has resulted in Lab-on-a-CD systems. The centrifugal microfluidic, or rotation-driven microdevice (RDM), platform offers unique advantages in ease of automation and portability. Multiple fluidic processing steps, in parallel or in a series, can be automated by controlling rotation speed, direction, and duration, ultimately allowing for fluid manipulation without the need for syringe-based or pneumatic pumps. RDMs also allow rapid screening of one drug sample to occur on a single device, where multiple colorimetric test ampules would have been needed otherwise, presenting an advantage for covering a wide range of presumptive tests simultaneously. The minimal instrumentation needed for RDM operation contributes to reduction in cost and expands the potential for user-friendly device operation.

While colorimetric presumptive field test kits for illicit drugs are more portable than conventional instrumentation, the reliance on subjective interpretation of color and proper operation can be problematic. Common complications arise in field-testing from subjective color interpretation, colorblindness, on-site environmental limitations, and sequential testing. In fact, 8% of males of Northern European descent have difficulty with color interpretation, causing concern for testing methods where color interpretation is used as a diagnostic tool. Additionally, presumptive testing kits are vulnerable to on-site environmental conditions when kits are stored over time in the truck of a police vehicle, affected by various temperature and humidity conditions, leading to several test kits being used to verify results. Other environmental conditions resulting from reflecting color of police vehicle lights flashing may hinder color interpretations.

Furthermore, additives in field samples cannot be accounted (or controlled) for in current colorimetric tests and can interfere with the interpretation of color change. Strictly, only color changes that directly match the kit instructions are considered positive for a particular drug and all other results, including partial color changes or insufficient color changes, will require additional on-site analysis or remain inconclusive at the scene. Additives can commonly lead to false positive results or alter the color change leading to false negative results. With the presence of additional uncontrolled substances commonly found in most drug samples, and with the increasing development of designer drugs, a burden is placed on local and state laboratories to verify field samples or alleviate inconclusive results. Also, the amount of sample used to conduct the test is critical for correct identification and can lead to false negative and positive results due to the sensitivity of the colorimetric reaction. The high susceptibility for test results demands a new approach: a technology that provides a chemical analysis system with an electronic colorimetric detector, removing the subjective component from the analysis. A non-subjective detection method that utilizes various image parameters to reveal subtle variations in color changes, that can be associated with additives in drug samples, is necessary.

While a microfluidic device for detection of illicit drugs using capillary electrophoresis has been described is, it represents an instrument-intensive approach that is not likely compatible for presumptive field analyses. A more practical, minimalist approach has been described by Bell et al. for colorimetric testing of controlled substances using a microfluidic device. This was the first account utilizing a microfluidic device for presumptive color testing for illicit drugs. With microfluidic architecture wet-etched into glass, they were able to develop a device to detect methamphetamine, amphetamine, cocaine, and oxycodone, and did so in an impressive 15 sec. However, the glass microdevice required clean room facilities for fabrication, creating limitations in cost-effectiveness, and still required a subjective analysis of color changes. We proffer that a solution to this problem lies in the laser print, cut and laminate (PCL) protocol that we have previously described. This method offers a means to fabricate sophisticated microfluidic architectures using inexpensive, commercial off-the-shelf materials and instrumentation to ultimately combine multiple colorimetric tests into a single device for a cost-effective and rapid on-site screening technique. The devices are fabricated from polyester overhead transparencies using a laser printer, laser cutter, and office laminator. In an effort to enhance current subjective field methods, we present a polyester-toner RDM requiring little training for device operation with proof of an explicit image analysis method for interpreting results. This detection utilizes thresholds associated with image parameters from resulting colorimetric reactions in the presence of specific drugs to identify unknown field samples. Common illicit drugs found in law enforcement, such as cocaine, methamphetamine, and amphetamine were used for proof of concept. Drug solutions were made from common field sampling amounts found at the scene to develop the microdevice, leading to a detection method with an elevated rate for success when translated to field analyses.

### Experimental Methods

### Materials

Cocaine, methamphetamine, and amphetamine were all purchased from Cerilliant (Round Rock, Tex.) Coalt thiocyanate, caffeine, lidocaine, acetylsalicylic acid, starch, and dextrose were all purchased from Sigma Aldrich (St. Louis, Mo.). Simon's reagent was purchased through a commercial vendor (DanceSafe).

### Preparation of Drug Samples

Drug samples were dried under nitrogen and re-constituted in stock solution to generate samples that were five-times the starting concentrations, for a final concentration of 5.0 mg/mL. Samples were then serial diluted to various concentrations and used within the same day.

### Fabrication of Polyester-Toner Devices

The laser PCL method used for polyester-toner device fabrication has been described previously. The microfluidic device designs used for threshold determination and drug detection are shown in FIGS. 1A-1F. Both devices were five layers, comprised of alternating polyester and toner-coated polyester layers. The toner-coated layers were made by printing two layers of black toner using a HP LaserJet 4000 printer onto both sides of a single transparency sheet. Device features including channels, inlets, mixing wells, detection chambers, and air vents were then laser-ablated into the toner layers using a VersaLASERVLS3.50 system to define the device architecture. Additionally, the toner was used as an adhesive to bond the device during lamination (with three passes through the laminator) at >160° C. using an UltraLam 250B.

The threshold determination device (FIG. 1A) had two nearly identical channel architectures overlaid and exploited for mixing. Two separate inlets provided access to two separate detection chambers for holding 1 μL, and 3 μL volumes, and each detection chamber was roughly 124 μm in thickness, the size of one laser-ablated toner sheet. Both detection chambers had entrances to a larger mixing well, with approximately 348 μm thickness from three laser-ablated layers. Capillary action held each solution in the detection chambers until the solutions were centrifugally forced to the peripheral mixing well at 1,000 RPM.

The drug detection device (FIG. 1D) had a number of features for fluidic control including device symmetry, capillary valves and siphon valves, serpentine channels, and strategically placed air vents. The sample solution enters through the inlet and flows into both sides of the device. The solution remains in the top square section of the reagent domain and is held there by utilizing geometry through severe chamber widening and air vent placement, which effectively creates an air pocket around the vent. The siphon valve can then prime while the sample interacts with the reagents before completely filling the serpentine channel. Once primed, the solution is spun into the serpentine channel to assure appropriate mixing of sample and reagent. The solution is then kept in the serpentine channel until the spin speed overcomes the capillary valve due to an extreme increase in well size compared to the serpentine channel. The channel is one laser-ablated layer and the final mixing well is three laser-ablated layers.

### Microdevice Control

The spin device system consisted of a Sanyo Denki Sanmotion series stepper motor controlled by a Pololu DRV8825 stepper motor driver in full step mode. The motor was mounted on a custom made support structure cut from poly(methyl methacrylate) to immobilize the motor during rotation. Motion control profiles were generated using a Parallax Propeller microcontroller, programmed in the native programming language. A printed circuit board was designed using EAGLE CAD software containing the microcontroller, motor drivers, and associated components for power regulation, heat sinking, and serial communication with an external computer terminal.

After sample addition, the device spin protocol for threshold determination was as follows: spin 1,000 RPM for 3 sec (100 angular acceleration) followed by 1,000 RPM, four replicates, for 5 sec (200 angular acceleration). Complete backfilling of the sample into the detection chambers was achieved before each consecutive spin. After sample addition, the drug detection device spin protocol was as follows: spin 600 RPM for 3 sec (100 angular acceleration) then 600 RPM for 5 sec (200 angular acceleration), followed by mixing which included alternating between clockwise and counterclockwise spin directions at 1,000 RPM for three replicates (200 angular acceleration).

### Image Analysis

The resulting color changes from drug-specific colorimetric reagents were analyzed using hue and saturation image parameters. Reactions chambers within the microdevices were scanned after the completed spin protocols using an EPSON Perfection V100 Photo Scanner with 1200 dpi resolution. The scanned images were saved as TIFF files and the color change in the device detection windows were cropped using ImageJ. The cropped images were then analyzed to determine color hue and saturation using a Mathematica algorithm, written in-house. The image parameter that best discriminated positive drug samples from negatives was chosen to define threshold values.

### Results and Discussion

### Determining Thresholds

To develop a more automated and objective system for narcotics detection, a means of quantitatively and independently measuring drug-specific color changes is essential. Several individual image parameters including the red, green and blue channels (from the RBG color model), and hue, saturation, and brightness (from HSB) were used in initial attempts to analyze color changes. The red, green and blue channels of an image were analyzed individually to determine the dynamic range associated with specific colorimetric reactions when the compiled RGB histogram was not sufficient (FIGS. 1G-1F). The HSB color model is derived from RGB, with hue described as different colors that are independent of intensity or brightness, and saturation is the intensity parameter. Individually, hue or saturation can be used to analyze all potential color changes to define the shade of color or the intensity of the color change, while the brightness of the image is held constant by the scanner settings. Ultimately, due to the large dynamic ranges and initial experiments, hue and saturation were chosen as the most promising image parameters to use for image analysis, and were used for the remainder of the studies.

The appropriate image analysis parameter—hue or saturation—needed to be defined for the quantitative detection of cocaine, methamphetamine, and amphetamine using cobalt thiocyanate and the Simon's reagent (FIGS. 10A and 10B). Various concentrations of cocaine, methamphetamine, and amphetamine were detected using the threshold-determination polyester-toner RDM (FIG. 1A) to analyze the color changes in terms of hue and saturation (FIG. 1B). Reagent was pipetted into one channel inlet and sample into the other, with capillary action facilitating the filling of the fluidic structure. A passive valve at the base of the detection area impeded capillary flow by increasing the channel dimensions, which stopped each solution from entering the mixing domain. The device was spun at a speed sufficient to overcome the capillary valve created at the base of the detection area; 1,000 RPM was used. Rotation alone allowed for mixing of the two reagents in the mixing domain. Once stopped, the partially mixed solution would return to the separate chambers on different levels of the 5-layer device. This ‘spin-stop’ mixing protocol was repeated four times to generate a homogenous mixture. After the spin protocol was performed, a TIFF image file of the device was captured using a photo scanner. The detection areas in the scanned image were cropped and used for image analysis.

The image analysis results for cocaine reacted with the colorimetric reagent, cobalt thiocyanate, are shown in FIGS. 11A and 11B and reported using arbitrary units (A.U.) from 0 to 1 by dividing the hue values by 360° and saturation values by 100%. Due to the scanner settings and the architecture of the detection area (i.e., the small path length), the hue values for a positive and negative cocaine samples did not differ significantly with image analysis (FIG. 11A). The subtle variations in hue for different concentrations made it difficult to define an absolute threshold value indicative of a sample ‘positive’ for cocaine. Hence, saturation was evaluated as a parameter using the same images and, as seen in FIG. 11B, the results show a direct linear relationship between the saturation value and the concentration of cocaine, with acceptable correlation (R²=0.9846). Using three-times the standard deviation of a negative sample, a threshold value for cocaine was ultimately defined as 0.098 A.U. All samples with saturation values greater than 0.098 A.U. were considered positive for cocaine, and conversely, samples with saturation values below the threshold were considered negative for cocaine.

The identical analytical approach was applied to methamphetamine and amphetamine with the Simon's colorimetric reagent to define threshold values for each compound. The hue image analysis results for various concentrations of methamphetamine and amphetamine are given in FIG. 12, and the data show that hue is an acceptable parameter for judging the presence or absence of methamphetamine using this reagent. In contrast to cocaine detection, two values are necessary for methamphetamine detection because the resulting values are associated with various hues; for example, as a value approaches 1 A.U., red is the associated color, and as a value approaches 0.5 A.U., the associated color is blue. A range of hue values for methamphetamine detection were defined as three-times the standard deviation of the average hue for concentrations varying between 2-5 mg/mL, and were determined to be 0.532 through 0.810 A.U. The values outside of this defined range are associated with colors that do not correlate to a positive result for methamphetamine with confidence. Although these hue boundaries defined here exclude the 1 mg/mL sample concentration, these results are adequate for detecting methamphetamine, primarily because current methods utilize greater amounts of drug sample for analysis. Additionally, the colorimetric reaction of amphetamine should appear as a negative sample for methamphetamine, which was consistent with the hue results. In the future, an additional test reagent, in combination with the Simon's reagent, will be needed to confirm the presence of amphetamine.

There is a kinetic component to the ‘development of color’ in the reaction of drug with Simon's reagent and cobalt thiocyanate, making the timing of image capture critical. Images were captured at the 3, 6, and 12-minute point after reaction of cocaine and methamphetamine with the appropriate drug-specific reagents, and over a range of drug concentrations (FIGS. 13A and 13B). The differences in hue for 2-5 mg/mL methamphetamine became increasingly greater with image capture after the 3-minute point (FIG. 13A). Also, the standard deviations between hue values for 2-5 mg/mL methamphetamine increased over time compared to image capture at 3 minutes. Additionally, 3 minutes was the only time point where 1 mg/mL methamphetamine resulted in a hue value greater than 0 mg/mL methamphetamine, potentially detecting methamphetamine sample at lower concentrations. Image capture at 3 minutes was implemented for additional analyses for methamphetamine. The saturation values for cocaine varied minimally when analyzed at different time points (FIG. 13B). Cocaine analysis at 3 minutes was selected, a faster analysis time than current methods used to validate these colorimetric tests, allowing methamphetamine and cocaine analysis to take place using the same image, which is advantageous for field testing.

### Using Thresholds in Detection

Thresholds provide an effective method for qualitative assessment and, in this case, for the presence or absence of cocaine and methamphetamine. Using the analytical fluidic spin system and the accompanying image analysis, a standard sample mixture (equal vol/vol) containing both cocaine and methamphetamine was reacted using the Simon's and cobalt thiocyanate reagents with subsequent hue and saturation image analysis (FIGS. 14A and 14B). Resulting hue values from addition of the Simon's reagent were analyzed using the defined range for methamphetamine detection (FIG. 14A). Cocaine did not interfere with detecting methamphetamine in the standard mixture or detecting the absence of methamphetamine in a solely cocaine sample. Resulting saturation values from the addition of cobalt thiocyanate were analyzed using the determined cocaine threshold (FIG. 14B). Methamphetamine did not interfere with detecting cocaine in the standard mixture or detecting the absence of cocaine in a solely methamphetamine sample. These results demonstrate that this method can detect each drug component in a mixture of more than one drug using defined detection parameters.

### Sample Additives

In considering the effect of interferents (additives or contaminants), thresholds are critical in determining the potential for false negative/positive results in an operational environment, an issue of significant interest with presumptive testing. Methamphetamine and cocaine were analyzed with common drug additives using the defined spin and image analysis methods and results are shown in FIGS. 15A and 15B. Common cutting agents, acting as fillers, such as starch, dextrose, and aspirin have been reported, along with common adulterants like lidocaine and caffeine. When Simon's reagents were used with starch and dextrose and no methamphetamine present, all hue values fell below the lower range of 0.532 A.U. resulting in no false positive results for these additives. Methamphetamine was spiked with either starch or dextrose (equal w/w) for 1-4 mg/mL. These additives had little effect on detecting methamphetamine at 2-4 mg/mL concentrations, indicating no false negative effect (FIGS. 15A and 15B). The 1 mg/mL methamphetamine hue values hovered around the lower hue limit for detecting methamphetamine and, with the standard deviations shown in FIG. 15A, the detection would be equivocal. Ultimately, these experiments showed that no false positive or negative results were generated from methamphetamine samples in the presence of these two additives.

Samples containing cocaine in the presence of lidocaine, caffeine, or aspirin (equal w/w) were reacted with cobalt thiocyanate and the subsequent color was analyzed for saturation. As shown in FIG. 15B, lidocaine, caffeine, or aspirin in the absence of cocaine fell just above the defined threshold of 0.098 A.U., as well as the control sample with no additives, due to slight differences in sample preparation when concentrating cocaine to make serial dilutions of relevant concentrations. The threshold value can be normalized to account for this difference using the control (no additives present) data within this study. More importantly, negative cocaine samples with caffeine and aspirin additives have standard deviations that overlap with the control sample and saturation values lower than the 1 mg/ml samples. The lidocaine-additive sample showed a saturation value slightly higher than the negative control indicating a false positive result, a trend that has been reported previously. The benefit of this detection method for cocaine is that differences in the color for varying concentrations of sample are defined, which can aid in determining false positives over a subjective color analysis technique. To account for additives, three times the standard deviation of all negative cocaine samples containing additives, and including the control, is 0.148 A.U. This new value of 0.148 A.U. can be used in conjunction with the original threshold of 0.098 A.U. to identify positive samples with greater confidence. A saturation value between 0.098 and 0.148 A.U. is within a range of less confidence and can be used to determine where false positives may be detected to prevent incorrect identification of a sample. When possible, a saturation value in this range should use additional analysis by increasing the amount of cocaine used.

### Unknown Sample Analysis

A new polyester-toner device for drug detection (FIG. 1D) was designed to perform two separate colorimetric reactions with a single sample aliquot. Cocaine colorimetric detection uses a one-step reaction, whereas the methamphetamine colorimetric reaction requires two steps. This two-step reaction required additional device architecture to be implemented to allow the sample to react with the first reagent and mix fully before moving the sample to the second reagent. Hydrophobic patches of toner are commonly used on our devices as valves to further control fluidic movement, however these patches are ineffective when using organic solvents such as those in drug standards. To overcome this, an alternate microfluidic architecture and valving method was implemented.

First, the cocaine reagent was spotted and dried in the top right reagent domain and the methamphetamine Simon's reagent B (sodium carbonate) was spotted and dried in the bottom left mixing domain. The capping polyester layer was then added for device bonding. Sample was pipetted into the inlet, and the sample split into both left and right top reagent domains due to the device channel symmetry (FIG. 1D). Once it was deposited in the top domains, the sample slowly started to dissolve the dried cocaine reagent. On the other side, the Simon's reagent A was added via pipette into the top left reagent domain through the inlet. The air vent of the bottom left domain was covered to allow the sample and Simon's reagent A to initially mix and remain isolated from Simon's reagent B while the device spins. The air vent was then manually opened and the reagent and sample further mixed while moving through the serpentine channel to the bottom domain where Simon reagent B was dried. Both the cocaine and the methamphetamine samples were then further mixed in the bottom domains by alternating device spin direction. The device was then scanned and analyzed using the color change in the final mixing/detection domain.

Four samples, containing methamphetamine only, cocaine only, both drugs (equal w/w), and no drug, were prepared and de-identified by a colleague resulting in no knowledge of the content prior to analysis. Each sample was analyzed using the defined saturation and hue values to verify if the system is able to correctly identify all samples using this image analysis and detection methods (FIGS. 16A and 16B). Unknown samples 2 and 4 resulted in hue values within the defined methamphetamine positive hue range and unknown samples 1 and 2 resulted in saturation values above the newly defined cocaine threshold value accounting for additives. From these results, sample 1 was identified as positive for cocaine, sample 2 was identified as positive for both cocaine and methamphetamine, sample 3 was identified as negative for both drugs, and sample 4 was identified as positive for methamphetamine only. These results were confirmed as the correct sample compositions.

### Conclusions

We have demonstrated an enhanced method for presumptive field-testing of illicit drugs. Developed methods were used to define detection parameters for cocaine and methamphetamine using image analysis. Once detection thresholds were defined, the image analysis methods were used to detect cocaine and methamphetamine in a mixture of both compounds as well as in the presence of various common drug additives. When necessary, image thresholds were adjusted for further studies to account for additives.

Four unknown samples were then correctly identified for cocaine and methamphetamine using the drug detection RDM with a single sample input. For further advancement toward a field device, the current detection method will need to be transferred to a more portable image analysis method, such as a cell phone application (FIGS. 8A-8E). A controlled image analysis environment (FIG. 8A) is critical for accurate and reproducible cell phone detection. One problem we are going to face when integrating more drug detection chambers into the RDM in the future is valving solutions that are unaffected by hydrophobic toner patches, the current valving method used with polyester-toner devices.

The devices, systems and methods described herein provide new and useful advancements in detection and identification technology, including: First narcotics detection device on a centrifugal platform, First explosives detection device on a centrifugal platform, First polyester-toner device to incorporate inkjet printing reagents, First non-paper based microfluidic device to incorporate paper punches for reagent storage, First reagent storage stability study on polyester-toner devices, First incorporation of laser and centrifuge-pneumatic valves on polyester-toner devices specifically for valving organic solvents, First interpretation of color change on a microfluidic device using a cell phone application for hue and saturation image parameters, First interpretation of color change on a microfluidic device for drugs and explosives colorimetric detection using hue and saturation parameters and later assessing color change with hue and saturation in the presence of contaminants and additives, and Unique demonstration of a polyester-toner microfluidic device incorporating reagent storage options, centrifugal platform, laser valve, centrifugal valve, and cell phone detection with custom-built cell phone holder.

The devices, systems, compositions, apparatuses, and methods of various embodiments of the invention disclosed herein may utilize aspects disclosed in the following references, applications, publications and patents and which are hereby incorporated by reference herein in their entirety (and which are not admitted to be prior art with respect to the present invention by inclusion in this section):

### EXAMPLES OF RELATED TECHNOLOGY

1. Colorimetric detection on microfluidic devices:
   Al-Hetlani et al. [23] reports on a microfluidic device for detection of illicit drugs using capillary electrophoresis not colorimetric detection.
   Bell et al. [24] reports the only other colorimetric test for controlled substances on microfluidic device.
2. Current polyester toner microfluidic devices:
   Do Lago et al. [25] demonstrates the first polyester-toner microfluidic device.
   Duarte et al. [26] demonstrates the first DNA extraction performed on a polyester-toner device.
3. Centrifugal device that uses paper:
   Hwang et al. [27] reports incorporating paper into a centrifugal microdevice to aid in back-filling.
4. Inkjet printing onto microdevice:
   Abe et al. [28] first uses inkjet printing for complete paper-based microdevice fabrication through patterning channels and depositing of reagents.
1. Hargreaves, M. D., et al., Analysis of seized drugs using portable Raman spectroscopy in an airport environment—a proof of principle study. Journal of Raman Spectroscopy, 2008. 39(7): p. 873-880.
2. Valussi, S. and M. Underhill, Raman and infrared techniques for fighting drug-related crime: a preliminary assessment. PROCEEDINGS OF SPIE—THE INTERNATIONAL SOCIETY FOR OPTICAL ENGINEERING, 2006. 6402.
3. Manz, A., N. Graber, and H. M. Widmer, MINIATURIZED TOTAL CHEMICAL-ANALYSIS SYSTEMS—A NOVEL CONCEPT FOR CHEMICAL SENSING. Sensors and Actuators B-Chemical, 1990. 1(1-6): p. 244-248.
4. Manz, A., et al., Miniaturization of Chemical Analysis Systems—A Look into Next Century's Technology or Just a Fashionable Craze?. Chimia 1991. 45: p. 103.
5. Le Roux, D., et al., An integrated sample-in-answer-out microfluidic chip for rapid human identification by STR analysis. Lab on a Chip, 2014. 14(22): p. 4415-4425.
6. Chin, C. D., et al., Mobile Device for Disease Diagnosis and Data Tracking in Resource-Limited Settings. Clinical Chemistry, 2013. 59(4): p. 629-640.
7. Madou, M. J. and G. J. Kellogg, LabCD: a centrifuge-based microfluidic platform for diagnostics. Proc. SPIE Systems and Technologies for Clinical Diagnostics and Drug Discovery, 1998. 3259: p. 80-93.
8. Fiorini, G. S. and D. T. Chiu, Disposable microfluidic devices: fabrication, function, and application. Biotechniques, 2005. 38(3): p. 429-446.
9. Xia, Y. N. and G. M. Whitesides, Soft lithography. Angewandte Chemie-International Edition, 1998. 37(5): p. 550-575.
10. Becker, H. and C. Gartner, Polymer microfabrication methods for microfluidic analytical applications. Electrophoresis, 2000. 21(1): p. 12-26.
11. Whitesides, G. M., et al., Soft lithography in biology and biochemistry. Annual Review of Biomedical Engineering, 2001. 3: p. 335-373.
12. Coltro, W. K. T., et al., Toner and paper-based fabrication techniques for microfluidic applications. Electrophoresis, 2010. 31(15): p. 2487-2498.
13. Thompson, B. L., et al., Inexpensive, rapid prototyping of microfluidic devices using overhead transparencies and a laser print, cut and laminate fabrication method. Nature Protocols, 2015. 10(6): p. 875-886.
14. NIK Narcotics Field Drug Test Kits. 2014; Available from: http://www.alternateforce.net.
15. Madou, M., et al., Lab on a CD, in Annual Review of Biomedical Engineering. 2006, Annual Reviews: Palo Alto. p. 601-628.
16. Lisowski, P. and P. K. Zarzycki, Microfluidic Paper-Based Analytical Devices (mu PADs) and Micro Total Analysis Systems (mu TAS): Development, Applications and Future Trends. Chromatographia, 2013. 76(19-20): p. 1201-1214.
17. Costa, M. N., et al., A low cost, safe, disposable, rapid and self-sustainable paper-based platform for diagnostic testing: lab-on-paper. Nanotechnology, 2014. 25(9).
18. Martinez, A. W., et al., Diagnostics for the Developing World: Microfluidic Paper-Based Analytical Devices. Analytical Chemistry, 2010. 82(1): p. 3-10.
19. Mark, D., et al., Centrifugo-pneumatic valve for metering of highly wetting liquids on centrifugal microfluidic platforms. Lab on a Chip, 2009. 9(24): p. 3599-3603.
20. Garcia-Cordero, J. L., et al., Optically addressable single-use microfluidic valves by laser printer lithography. Lab on a Chip, 2010. 10(20): p. 2680-2687.
21. Cohen, D. J., R. C. Morfino, and M. M. Maharbiz, A Modified Consumer Inkjet for Spatiotemporal Control of Gene Expression. Plos One, 2009. 4(9): p. 8.
22. Yager, P., et al. Microfluidics 2.0. 2010; Available from: http://www.mf20.org/.
23. Al-Hetlani, E., Forensic drug analysis and microfluidics. Electrophoresis, 2013. 34(9-10): p. 1262-1272.
24. Bell, S. C. and R. D. Hanes, A microfluidic device for presumptive testing of controlled substances. Journal of Forensic Sciences, 2007. 52(4): p. 884-888.
25. do Lago, C. L., et al., A dry process for production of microfluidic devices based on the lamination of laser-printed polyester films. Analytical Chemistry, 2003. 75(15): p. 3853-3858.
26. Gabriel, E. F. M., et al., Characterization of microchip electrophoresis devices fabricated by direct-printing process with colored toner. Electrophoresis, 2013. 34(15): p. 2169-2176.
27. Hwang, H., et al., Paper on a disc: balancing the capillary-driven flow with a centrifugal force. Lab on a Chip, 2011. 11(20): p. 3404-3406.
28. Abe, K., K. Suzuki, and D. Citterio, Inkjet-printed microfluidic multianalyte chemical sensing paper. Analytical Chemistry, 2008. 80(18): p. 6928-6934.
International Patent Application No. PCT/US2013/074152 entitled “FREQUENCYBASED FILTERING OF MECHANICAL ACTUATION USING FLUIDIC DEVICE,” filed Dec. 10, 2013.
U.S. patent application Ser. No. 13/849,691 entitled “Electrostatic Actuation for Management of Flow in Micro Total Analysis Systems and Related Method Thereof,” filed Mar. 25, 2013.
U.S. patent application Ser. No. 13/294,908 entitled “Electrostatic Actuation for Management of Flow in Micro-Total Analysis Systems (u-TAS) and Related Method Thereof,” filed Nov. 11, 2011; U.S. Pat. No. 8,403,294, issued Mar. 26, 2013.
U.S. patent application Ser. No. 11/665,326 entitled “Electrostatic Actuation for Management of Flow in Micro Total Analysis Systems and Related Method Thereof,” filed Apr. 13, 2007; U.S. Pat. No. 8,056,881, issued Nov. 15, 2011.
International Patent Application No. US2005/036675 entitled “Electrostatic Actuation for Management of Flow in Micro Total Analysis Systems and Related Method Thereof,” filed Oct. 13, 2005.
U.S. patent application Ser. No. 13/699,983 entitled “METHOD FOR DETECTING NUCLEIC ACIDS BASED ON AGGREGATE FORMATION,” filed Nov. 26, 2012; U.S. Patent Application Publication No. 2013/0203045, Aug. 8, 2013.
International Patent Application No. PCT/US2011/038166 entitled “METHOD FOR DETECTING NUCLEIC ACIDS BASED ON AGGREGATE FORMATION,” filed May 26, 2011.
U.S. patent application Ser. No. 13/474,420 entitled “Passive Components for Micro-Fluidic Flow Profile Shaping and Related Method Thereof,” filed May 17, 2012; U.S. Patent Application Publication No. 2012/0222747, Sep. 6, 2012.
U.S. patent application Ser. No. 12/064,557 entitled “Passive Components for Micro-Fluidic Flow Profile Shaping and Related Method Thereof,” filed Feb. 22, 2008; U.S. Pat. No. 8,220,493, issued Jul. 17, 2012.
International Patent Application No. PCT/US2006/032717 entitled “Passive Components for Micro-Fluidic Flow Profile Shaping and Related Method Thereof,” filed Aug. 23, 2006. International Patent Application No. PCT/US2012/036105 entitled “METHOD AND SYSTEM FOR HIGH THROUGHPUT OPTICAL AND LABEL FREE DETECTION OF ANALYTES,” filed May 2, 2012.
U.S. patent application Ser. No. 13/505,406 entitled “VERSATILE, VISIBLE METHOD FOR DETECTING POLYMERIC ANALYTES,” filed May 1, 2012; U.S. Patent Application Publication No. 2013/0084565, Apr. 4, 2013.
U.S. patent application Ser. No. 13/116,659 entitled “METHOD FOR DETECTING NUCLEATED CELLS,” filed May 26, 2011.
International Patent Application No. PCT/US2010/002883 entitled “VERSATILE, VISIBLE METHOD FOR DETECTING POLYMERIC ANALYTES,” filed Nov. 3, 2010.
U.S. patent application Ser. No. 12/879,810 entitled “DETECTION OF POLYMERIC ANALYTES,” filed Sep. 10, 2010; U.S. Patent Application Publication No. 2011/0070660, Mar. 24, 2011.
International Patent Application No. PCT/US2009/036983 entitled “DETECTION OF POLYMERIC ANALYTES,” filed Mar. 12, 2009.
U.S. patent application Ser. No. 12/892,618 entitled “DNA EXTRACTION USING A PHOTO-POLYMERIZED MONOLITH IN A CAPILLARY,” filed Sep. 28, 2010; U.S. Patent Application Publication No. 2011/0086181, Apr. 14, 2011.
U.S. patent application Ser. No. 11/885,181 entitled “Grafted Photo-Polymerized Monolithic Column,” filed Aug. 28, 2007; U.S. Pat. No. 7,815,802, issued Oct. 19, 2010.
International Patent Application No. US2006/006845 entitled “DNA Extraction Using a Photo-Polymerized Monolith in a Capillary,” filed Feb. 28, 2006. (01106-03)
U.S. patent application Ser. No. 12/090,233 entitled “Integrated Microfluidic Analysis Systems,” filed Apr. 14, 2008.
International Patent Application No. US2006/039809 entitled “Integrated Microfluidic Analysis Systems,” filed Oct. 12, 2006.
U.S. patent application Ser. No. 12/089,320 entitled “Microchip-based Acoustic Trapping or Capture of Cells for Forensic Analysis and Related Method Thereof,” filed Apr. 4, 2008. International Patent Application No. PCT/US2006/038943 entitled “Microchip-based Acoustic Trapping or Capture of Cells for Forensic Analysis and Related Method Thereof,” filed Oct. 4, 2006.
U.S. patent application Ser. No. 11/989,794 entitled “Microdevices for Chemical Sensing and Chemical Actuation,” filed Jan. 31, 2008; U.S. Pat. No. 8,343,755, issued Jan. 1, 2013.
International Patent Application No. PCT/US2006/030127 entitled “Microdevices for Chemical Sensing and Chemical Actuation,” filed Aug. 1, 2006.
U.S. patent application Ser. No. 11/793,428 entitled “ Use of Microwaves for Thermal and Non-Thermal Applications in Micro and Nanoscale Devices,” filed Jan. 7, 2008; U.S. Patent Application Publication No. 2008/0277387, Nov. 13, 2008.)
International Patent Application No. US2005/046756 entitled “The Use of Microwaves for Thermal and Non-Thermal Applications in Micro and Nanoscale Devices,” filed Dec. 22, 2005.
International Patent Application No. PCT/US2007/088662 entitled “Non-Contact Thermal Control of Small Volume and Related Apparatus Thereof,” filed Dec. 21, 2007.
International Patent Application No. PCT/US2007/083964 entitled “DNA Purification in a Multi-Stage, Multi-Phase Microchip,” filed Nov. 7, 2007.
U.S. patent application Ser. No. 11/884,351 entitled “Nucleic Acid Isolation Methods and Materials and Devices Thereof,” filed Aug. 15, 2007.
International Patent Application No. PCT/US2006/005241 entitled “Nucleic Acid Isolation Methods and Materials and Devices Thereof,” filed Feb. 15, 2006.
U.S. patent application Ser. No. 11/664,297 entitled “Localized Control of Thermal Properties on Microdevices and Applications Thereof,” filed Mar. 19, 2007.
International Patent Application No. US2005/034674 entitled “Localized Control of Thermal Properties on Microdevices and Applications Thereof,” filed Sep. 29, 2005.
U.S. patent application Ser. No. 10/535,926 entitled “Isolation of Sperm Cells from Other Biological Materials Using Microfabricated Devices and Related Methods Thereof,” filed May 23, 2005.
International Patent Application No. US2003/037205 entitled “Isolation of Sperm Cells from Other Biological Materials Using Microfabricated Devices and Related Methods Thereof,” filed Nov. 20, 2003.
U.S. patent application Ser. No. 10/530,728 entitled “Methods and Systems for Multiplexing IR-Mediated Heating on a Microchip,” filed Apr. 8, 2005.
International Patent Application No. US2003/031806 entitled “Methods and Systems for Multiplexing IR Mediated Heating on a Microchip,” filed Oct. 8, 2003.
International Patent Application No. US2005/005490 entitled “Method and System for Eluting Cells,” filed Feb. 22, 2005
U.S. patent application Ser. No. 10/520,763 entitled “Hybrid Polymers for Functional Tuning of Microfludic Device Surfaces,” filed Jan. 10, 2005; U.S. Patent No.
International Patent Application No. US2003/022162 entitled “Hybrid Polymers for Functional Tuning of Microfludic Device Surfaces,” filed Jul. 15, 2003.
U.S. patent application Ser. No. 10/517,980 entitled “Apparatus and Method for Purification of Nucleic Acids,” filed Dec. 13, 2004; U.S. Pat. No. 7,534,623, issued May 19, 2009 International Patent Application No. US2003/018403 entitled “Apparatus and Method or Purification of Nucleic Acids,” filed Jun. 11, 2003.
International Patent Application No. US2004/001276 entitled “Method for Microchip and Capillary Detection of Proteins in the Sub-μG/ML Range,” filed Jan. 20, 2004.
U.S. patent application Ser. No. 10/664,064 entitled “Remote Temperature Sensing of Small Volume and Related Apparatus Thereof,” filed Sep. 17, 2003.
International Patent Application No. US2003/029249 entitled “Remote Temperature Sensing of Small Volume and Related Apparatus Thereof,” filed Sep. 17, 2003.
U.S. patent application Ser. No. 10/432,141 entitled “Method for Orthogonal Analyte Stacking/Injection Systems in Electrophoresis,” filed May 16, 2003.
International Patent Application No. US01/43259 entitled “Method For Orthogonal Analyte Stacking/Injection Systems In Electrophoresis,” filed Nov. 19, 2001.
1. Hargreaves, K. Page, T. Munshi, R. Tomsett, G. Lynch and H. G. M. Edwards, Journal of Raman Spectroscopy, 2008, 39, 873-880.
2. S. Valussi and M. Underhill, Proceedings of SPIE—The International Society for Optical Engineering, 2006, 6402.
3. D. Le Roux, B. E. Root, J. A. Hickey, 0. N. Scott, A. Tsuei, J. Y. Li, D. J. Saul, L. Chassagne, J. P. Landers and P. de Mazancourt, Lab on a Chip, 2014, 14, 4415-4425.
4. K. M. Horsman, J. M. Bienvenue, K. R. Blasier and J. P. Landers, Journal of Forensic Sciences, 2007, 52, 784-799.
5. J. Wang, Analytica Chimica Acta, 2004, 507, 3-10.
6. M. J. Madou and G. J. Kellogg, Proc. SPIE Systems and Technologies for Clinical Diagnostics and Drug Discovery, 1998, 3259, 80-93.
7. R. Gorkin, J. Park, J. Siegrist, M. Amasia, B. S. Lee, J. M. Park, J. Kim, H. Kim, M. Madou and Y. K. Cho, Lab on a Chip, 2010, 10, 1758-1773.
8. J. A. B. Spalding, British Journal of General Practice, 1999, 49, 469-475.
9. M. Collins, H. Salouros and H. Swan, Recommended methods for the Identification and Analysis of Cocaine in Seized Materials, United Nations, Vienna, 2012.
10. S. L. Mikkelsen and K. O. Ash, Clinical Chemistry, 1988, 34, 2333-2336.
11. R. Haddoub, D. Ferry, P. Marsal and O. Siri, New Journal of Chemistry, 2011, 35, 1351-1354.
12. S. Laks, A. Pelander, E. Vuori, E. Ali-Tolppa, E. Sippola and I. Ojanpera, Analytical Chemistry, 2004, 76, 7375-7379.
13. A. Namera, A. Nakamoto, T. Saito and M. Nagao, Forensic Toxicology, 2011, 29, 1-24.
14. Y. Tsumura, T. Mitome and S. Kimoto, Forensic Science International, 2005, 155, 158-164.
15. E. Al-Hetlani, Electrophoresis, 2013, 34, 1262-1272.
16. S. C. Bell and R. D. Hanes, Journal of Forensic Sciences, 2007, 52, 884-888.
17. B. L. Thompson, Y. Ouyang, G. R. M. Duarte, E. Carrilho, S. T. Krauss and J. P. Landers, Nature Protocols, 2015, 10, 875-886.
18. C. L. do Lago, H. D. T. da Silva, C. A. Neves, J. G. A. Brito-Neto and J. A. F. da Silva, Analytical Chemistry, 2003, 75, 3853-3858.
19. L. J. Scott Jr., Microgram Journal 1973, 6, 179.
20. F. Feigel and V. Anger, Spot Tests in Organic Analysis, Elsevier, Amsterdam, 1966.
21. C. L. O'Neal, D. J. Crouch and A. A. Fatah, Forensic Science International, 2000, 109, 189-201.
22. D. Ciccarone, Primary Care, 2011, 38, 41-58.
23. Y. W. Ouyang, S. B. Want, J. Y. Li, P. S. Riehl, M. Begley and J. ders, Lab on a Chip, 2013, 13, 1762-1771.

### Various Notes & Examples

Example 1 is a substance determination system comprising: a chip comprising: a substrate; a microfluidic channel disposed on the substrate; a reagent enclosed in a portion of the microfluidic channel; and a substance inlet to the microfluidic channel; a centrifugal device configured to rotate the chip; and a microprocessor device configured to assess the reagent in the microfluidic channel.

In Example 2, the subject matter of Example 1 optionally includes wherein the microprocessor device includes a memory device, the memory device having stored therein reference values for hue and saturation of mixtures of the reagent with various substances.

In Example 3, the subject matter of Example 2 optionally includes wherein the microprocessor device includes a digital camera.

In Example 4, the subject matter of Example 3 optionally includes wherein the microprocessor device comprises a smartphone.

In Example 5, the subject matter of Example 4 optionally includes a housing configured to mate with the smartphone, the housing including the centrifugal device, wherein the housing aligns the digital camera of the smartphone with the reagent in the microfluidic channel.

In Example 6, the subject matter of any one or more of Examples 2-5 optionally include wherein the various substances include cocaine and methamphetamine.

In Example 7, the subject matter of Example 6 optionally includes wherein the reagent comprises octahedral cobalt.

In Example 8, the subject matter of any one or more of Examples 6-7 optionally include wherein the reagent comprises Simon's reagent.

In Example 9, the subject matter of any one or more of Examples 1-8 optionally include wherein the microprocessor device includes an optical sensor.

In Example 10, the subject matter of any one or more of Examples 1-9 optionally include wherein the microprocessor device includes a digital scanner.

In Example 11, the subject matter of any one or more of Examples 1-10 optionally include wherein the centrifugal device includes a spin motor.

In Example 12, the subject matter of any one or more of Examples 1-11 optionally include wherein the microfluidic channel comprises a polyester-toner device.

In Example 13, the subject matter of Example 12 optionally includes wherein the reagent is disposed in a paper punch.

In Example 14, the subject matter of any one or more of Examples 1-13 optionally include wherein the microfluidic channel is a dual-layer device.

In Example 15, the subject matter of any one or more of Examples 1-14 optionally include wherein the microfluidic channel is a dual-channel device.

In Example 16, the subject matter of any one or more of Examples 1-15 optionally include wherein the microfluidic channel includes: the substance inlet; a channel extending from the substance inlet; and a mixing domain connected to the channel.

In Example 17, the subject matter of Example 16 optionally includes wherein the microfluidic channel is configured to move a sample substance from the substance inlet to the mixing domain when the centrifugal device rotates the chip.

In Example 18, the subject matter of any one or more of Examples 16-17 optionally include wherein the reagent is located in the mixing domain.

In Example 19, the subject matter of any one or more of Examples 16-18 optionally include wherein the microfluidic channel further comprises a reagent domain, wherein the reagent is located in the reagent domain, the reagent domain positioned between the mixing domain and the substance inlet.

In Example 20, the subject matter of any one or more of Examples 16-19 optionally include wherein the microfluidic channel includes air vents.

In Example 21, the subject matter of any one or more of Examples 16-20 optionally include wherein the microfluidic channel includes a siphon valve.

In Example 22, the subject matter of any one or more of Examples 16-21 optionally include wherein the microfluidic channel includes a laser valve.

In Example 23, the subject matter of any one or more of Examples 16-22 optionally include wherein the microfluidic channel includes a serpentine channel.

In Example 24, the subject matter of any one or more of Examples 16-23 optionally include wherein the chip comprises a chip stack comprising: a top layer having the inlet and the reagent disposed thereon; a middle layer having the channel and the mixing domain; and a bottom layer; wherein the top layer and the middle layer are positioned such that the reagent aligns with the mixing domain.

In Example 25, the subject matter of Example 24 optionally includes wherein the top layer comprises a polyester laminate that is roughened where the reagent is located.

Example 26 is a method for identifying a substance, the method comprising: inserting a substance into an inlet in a microfluid detection device having a reagent disposed in a microfluid circuit connected to a mixing domain; spinning the microfluid detection device to move the substance and the reagent to the mixing domain; capturing a digital image of a reaction between the substance and the reagent; analyzing the digital image of the reaction to determine a color parameter; comparing the color parameter to a reference parameter of a reference composition; and assessing the comparison to determine if the substance is the reference composition.

In Example 27, the subject matter of Example 26 optionally includes outputting visible indicia of the comparison.

In Example 28, the subject matter of Example 27 optionally includes wherein the visible indicia comprises a digital graphical indication.

In Example 29, the subject matter of any one or more of Examples 26-28 optionally include activating a laser valve to release the substance while the microfluid detection device is spinning.

In Example 30, the subject matter of any one or more of Examples 26-29 optionally include activating a siphon valve to release a mixture of the substance and the reagent while the microfluid detection device is spinning.

In Example 31, the subject matter of any one or more of Examples 26-30 optionally include wherein spinning the microfluid detection device comprises attaching the microfluid detection device to a spin motor.

In Example 32, the subject matter of Example 31 optionally includes positioning the microfluid detection device within a housing containing the spin motor.

In Example 33, the subject matter of Example 32 optionally includes attaching a smartphone to the housing, wherein capturing a digital image of the reaction comprises using a digital camera of the smartphone to capture the digital image.

In Example 34, the subject matter of any one or more of Examples 26-33 optionally include wherein analyzing the digital image of the reaction to determine the color parameter comprises determining a hue of the digital image of the reaction.

In Example 35, the subject matter of any one or more of Examples 26-34 optionally include wherein analyzing the digital image of the reaction to determine the color parameter comprises determining a saturation of the digital image of the reaction.

In Example 36, the subject matter of any one or more of Examples 26-35 optionally include wherein comparing the color parameter to the reference parameter of the reference composition comprises comparing the color parameter to a threshold value of saturation.

In Example 37, the subject matter of Example 36 optionally includes wherein assessing the comparison to determine if the substance is the reference composition comprises determining that the substance is equivalent to the reference composition if the color parameter is greater than the threshold value of saturation.

In Example 38, the subject matter of any one or more of Examples 26-37 optionally include wherein comparing the color parameter to the reference parameter of the reference composition comprises comparing the color parameter to a range of hue values.

In Example 39, the subject matter of Example 38 optionally includes wherein assessing the comparison to determine if the substance is the reference composition comprises determining that the substance is equivalent to the reference composition if the color parameter is in the range of hue values.

In Example 40, the subject matter of Example 39 optionally includes wherein comparing the color parameter to the reference parameter of the reference composition comprises comparing the color parameter to a plurality of ranges of hue values.

Example 41 is a method of fabricating a microfluidic device for substance determination, the method comprising: forming a microfluidic channel architecture onto a substrate, the microfluidic channel architecture including an inlet, a passage, and a mixing domain; positioning a reagent adjacent the microfluidic channel architecture; and covering the substrate with a capping layer, the capping layer including an opening aligned with the inlet.

In Example 42, the subject matter of Example 41 optionally includes wherein covering the substrate comprises laminating the substrate.

In Example 43, the subject matter of Example 42 optionally includes wherein laminating the substrate comprises laminating the substrate with a polyester film.

In Example 44, the subject matter of Example 43 optionally includes wherein the laminating is performed with a laminating machine that applies heat and pressure to the polyester film.

In Example 45, the subject matter of any one or more of Examples 41-44 optionally include wherein forming a microfluidic channel architecture onto the substrate comprises printing the microfluidic channel architecture using toner.

In Example 46, the subject matter of Example 45 optionally includes wherein the printing is performed with a laser printer.

In Example 47, the subject matter of any one or more of Examples 41-46 optionally include wherein forming the microfluidic channel comprises laser ablating a toner layer disposed on the substrate.

In Example 48, the subject matter of any one or more of Examples 41-47 optionally include wherein positioning the reagent adjacent the microfluidic channel architecture comprises laser printing the reagent onto the capping layer.

In Example 49, the subject matter of Example 48 optionally includes wherein the substrate comprises a polyester film and the polyester film is roughened where the reagent is laser printed.

In Example 50, the subject matter of any one or more of Examples 41-49 optionally include wherein positioning the reagent adjacent the microfluidic channel architecture comprises positioning a piece of reagent paper adjacent the microfluidic channel architecture.

In Example 51, the subject matter of Example 50 optionally includes forming the reagent paper by: dropping reagent droplets onto filter paper to form a reagent patch; punching the reagent patch out of the filter paper to form the reagent paper; and positioning the reagent paper into a cavity in the microfluidic channel architecture.

In Example 52, the subject matter of any one or more of Examples 41-51 optionally include aligning the substrate and capping layer using an alignment tool having posts that extend through the substrate and the capping layer.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with rules and regulations pertaining to requirements of a complete patent application, to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

It should be appreciated that various sizes, dimensions, contours, rigidity, shapes, flexibility and materials of any of the components or portions of components in the various embodiments discussed throughout may be varied and utilized as desired or required.

It should be appreciated that while some dimensions may or may not be provided on the aforementioned figures, the device may constitute various sizes, dimensions, contours, rigidity, shapes, flexibility and materials as it pertains to the components or portions of components of the device, and therefore may be varied and utilized as desired or required.

It should be appreciated that the device and related components discussed herein may take on all shapes along the entire continual geometric spectrum of manipulation of x, y and z planes to provide and meet the structural demands and operational requirements. Moreover, locations and alignments of the various components may vary as desired or required.

It should be appreciated that any of the components or modules referred to with regards to any of the present invention embodiments discussed herein, may be integrally or separately formed with one another. Further, redundant functions or structures of the components or modules may be implemented. Moreover, the various components may be communicated locally and/or remotely with any user/clinician/patient or machine/system/computer/processor.

Moreover, the various components may be in communication via wireless and/or hardwire or other desirable and available communication means, systems and hardware. Moreover, various components and modules may be substituted with other modules or components that provide similar functions.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the intention and scope of the disclosure, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the intention and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

The claimed invention is:

1. A substance determination system comprising:
a chip comprising:
a substrate;
a microfluidic channel disposed on the substrate;
a reagent enclosed in a portion of the microfluidic channel; and
a substance inlet to the microfluidic channel;
a centrifugal device configured to rotate the chip; and
a microprocessor device configured to assess the reagent in the microfluidic channel.

2. The substance determination system of claim 1, wherein the microprocessor device includes a memory device, the memory device having stored therein reference values for hue and saturation of mixtures of the reagent with various substances.

3. The substance determination system of claim 2, wherein the microprocessor device includes a digital camera.

4. The substance determination system of claim 3, wherein the microprocessor device comprises a smartphone.

5. The substance determination system of claim 4, further comprising a housing configured to mate with the smartphone, the housing including the centrifugal device, wherein the housing aligns the digital camera of the smartphone with the reagent in the microfluidic channel.

6. The substance determination system of claim 2, wherein the various substances include cocaine and methamphetamine.

7. The substance determination system of claim 6, wherein the reagent comprises octahedral cobalt or Simon's reagent.

8. The substance determination system of claim 1, wherein the microfluidic channel comprises a polyester-toner device.

9. The substance determination system of claim 1, wherein the microfluidic channel includes:
the substance inlet;
a channel extending from the substance inlet; and
a mixing domain connected to the channel.

10. The substance determination system of claim 9, wherein the microfluidic channel is configured to move a sample substance from the substance inlet to the mixing domain when the centrifugal device rotates the chip.

11. The substance determination system of claim 9, wherein the microfluidic channel further comprises:
a reagent domain, wherein the reagent is located in the reagent domain, the reagent domain positioned between the mixing domain and the substance inlet; and
air vents.

12. A method for identifying a substance, the method comprising:
inserting a substance into an inlet in a microfluid detection device having a reagent disposed in a microfluid circuit connected to a mixing domain;
spinning the microfluid detection device to move the substance and the reagent to the mixing domain;
capturing a digital image of a reaction between the substance and the reagent;
analyzing the digital image of the reaction to determine a color parameter;
comparing the color parameter to a reference parameter of a reference composition; and
assessing the comparison to determine if the substance is the reference composition.

13. The method of claim 12, further comprising outputting visible indicia of the comparison, the visible indicia comprises a digital graphical indication.

14. The method of claim 12, wherein spinning the microfluid detection device comprises attaching the microfluid detection device to a spin motor disposed within a housing; and
further comprising attaching a smartphone to the housing, wherein capturing a digital image of the reaction comprises using a digital camera of the smartphone to capture the digital image.

15. The method of claim 12, wherein analyzing the digital image of the reaction to determine the color parameter comprises determining a hue of the digital image of the reaction.

16. The method of claim 12, wherein analyzing the digital image of the reaction to determine the color parameter comprises determining a saturation of the digital image of the reaction.

17. A method of fabricating a microfluidic device for substance determination, the method comprising:
forming a microfluidic channel architecture onto a substrate, the microfluidic channel architecture including an inlet, a passage, and a mixing domain;
positioning a reagent adjacent the microfluidic channel architecture; and
covering the substrate with a capping layer, the capping layer including an opening aligned with the inlet.

18. The method of claim 17, further comprising:
aligning the substrate and capping layer using an alignment tool having posts that extend through the substrate and the capping layer; and
laminating the substrate with a polyester film.

19. The method of claim 17, wherein forming a microfluidic channel architecture onto the substrate comprises printing the microfluidic channel architecture using toner.

20. The method of claim 17, wherein positioning the reagent adjacent the microfluidic channel architecture comprises laser printing the reagent onto the capping layer Or positioning a piece of reagent paper adjacent the microfluidic channel architecture.
